(19) United States
(12) Patent Application Publication
(10) Pub. No.: US 2026/0099222 A1
(43) Pub. Date: Apr. 9, 2026

(54) POSITION DETECTION METHOD, INTEGRATED CIRCUIT, AND SENSOR DEVICE

(71) Applicant: Wacom Co., Ltd., Saitama (JP)

(72) Inventors: Hiroshi MIZUHASHI, Saitama (JP); Fumitaka GOTO, Saitama (JP); Joo Hoon LEE, Saitama (JP)

(73) Assignee: Wacom Co., Ltd., Saitama (JP)

(21) Appl. No.: 19/359,125

(22) Filed: Oct. 15, 2025

Related U.S. Application Data
(63) Continuation of application No. PCT/JP2024/014586, filed on Apr. 10, 2024.

(30) Foreign Application Priority Data
Apr. 18, 2023 (JP) 2023-068142

(51) Int. Cl. G06F 3/038; G06F 3/0354; G06F 3/046; G06F 3/04883

(52) U.S. Cl. CPC G06F 3/038; G06F 3/03545; G06F 3/046; G06F 3/04883

(57) ABSTRACT

Provided is a position detection method including connecting each of a plurality of sending coil conductors provided in parallel to a driving circuit in a first connection mode, and detecting, by using detection coils, an alternating magnetic field generated by an indicator according to alternating magnetic fields simultaneously sent from the plurality of sending coil conductors in response to alternating current supplied from the driving circuit, to obtain a first result, connecting each of the plurality of sending coil conductors to the driving circuit in a second connection mode, and detecting, by using the detection coils, an alternating magnetic field generated by the indicator according to alternating magnetic fields simultaneously sent from the plurality of sending coil conductors in response to alternating current supplied from the driving circuit, to obtain a second result; and deriving a position of the indicator based on the first and second results.

### BACKGROUND OF THE INVENTION

### Technical Field

The present disclosure relates to a position detection method, an integrated circuit, and a sensor device.

### Description of the Related Art

An electromagnetic resonance method (EMR method) is one of known methods for detecting a position of an electromagnetic resonance pen within a panel face of a tablet-type device or the like. The tablet-type device using the EMR method has a pen detection sensor (hereinafter referred to as an “EMR sensor”) disposed within the panel face and a sensor controller connected to the EMR sensor. The EMR sensor includes a plurality of Tx coils arranged side by side in a y direction and a plurality of Rx coils arranged side by side in an x direction. An alternating magnetic field is sequentially transmitted from the plurality of Tx coils, and a reflection signal (hereinafter referred to as a “pen signal”) transmitted from the electromagnetic resonance pen is received by the sensor controller via the corresponding Rx coil for each sending of the alternating magnetic field. In this manner, the sensor controller detects a position of the electromagnetic resonance pen and receives data transmitted from the electromagnetic resonance pen. Japanese Patent No. 6698386 discloses an example of the EMR sensor.

Meanwhile, it is preferable that a signal to noise ratio of the pen signal received by the sensor controller have a largest possible ratio. Several methods are adoptable to improve the signal to noise ratio. One of these methods uses such an electromagnetic resonance pen configured to elongate a transmission period of the pen signal. This configuration is employed for the following reason. When a detection period of the pen signal by the sensor controller becomes N times longer, the received pen signal has an N-times higher level. Meanwhile, received noise has only an N^{1/2} higher level. However, when the transmission period of the pen signal is simply elongated, a different problem of less-frequent detection of the position may be caused. For solving this problem, the pen signal may be parallelly received by the sensor controller with use of a plurality of the Rx coils to elongate the transmission period of the pen signal, without lowering frequency of the position detection. In this case, however, a sufficient number of receiving circuits for allowing parallel reception are required, and hence, a circuit scale of the sensor controller increases.

### BRIEF SUMMARY DISCLOSURE

Accordingly, the present disclosure provides a position detection method, an integrated circuit, and a sensor device capable of improving a signal to noise ratio of a pen signal received by a sensor controller, without lowering frequency of position detection and without increasing a circuit scale of the sensor controller.

A position detection method according to an aspect of the present disclosure includes connecting each of a plurality of sending coil conductors provided in parallel to a driving circuit in a first connection mode in a first period, and detecting, by using a plurality of detection coils, a first alternating magnetic field generated by an indicator according to first alternating magnetic fields simultaneously sent from the plurality of sending coil conductors in response to first alternating current supplied from the driving circuit, to obtain a first result, connecting each of the plurality of sending coil conductors to the driving circuit in a second connection mode different from the first connection mode in a second period different from the first period, and detecting, by using the detection coils, a second alternating magnetic field generated by the indicator according to second alternating magnetic fields simultaneously sent from the plurality of sending coil conductors in response to second alternating current supplied from the driving circuit, to obtain a second result, and deriving a position of the indicator based on the first result and the second result.

An integrated circuit according to another aspect of the present disclosure is configured to be connected to a plurality of sending coil conductors provided in parallel, a driving circuit, and a plurality of detection coils, and includes at least one processor and at least one memory storing instructions that, when executed by the at least one processor, cause the integrated circuit to: connect each of the plurality of sending coil conductors to the driving circuit in a first connection mode in a first period, and detect, by using the detection coils, a first alternating magnetic field generated by the indicator according to first alternating magnetic fields simultaneously sent from the plurality of sending coil conductors in response to first alternating current supplied from the driving circuit, to obtain a first result; connect each of the plurality of sending coil conductors to the driving circuit in a second connection mode different from the first connection mode in a second period different from the first period, and detect, by using the detection coils, a second alternating magnetic field generated by the indicator according to second alternating magnetic fields simultaneously sent from the plurality of sending coil conductors in response to second alternating current supplied from the driving circuit, to obtain a second result; and derive a position of the indicator based on the first result and the second result.

A sensor device according to a further aspect of the present disclosure derives a position of an indicator. The sensor device includes a plurality of sending coil conductors provided in parallel, a driving circuit, a plurality of detection coils, and an integrated circuit connected to the plurality of sending coil conductors provided in parallel, the driving circuit, and the detection coils, in which the integrated circuit, in operation, connects each of the plurality of sending coil conductors to the driving circuit in a first connection mode in a first period, and detects, by using the detection coils, a first alternating magnetic field generated by the indicator according to first alternating magnetic fields simultaneously sent from the plurality of sending coil conductors in response to first alternating current supplied from the driving circuit, to obtain a first result, the driving circuit in a second connection mode different from the first connection mode in a second period different from the first period, and detects, by using the detection coils, a second alternating magnetic field generated by the indicator according to second alternating magnetic fields simultaneously sent from the plurality of sending coil conductors in response to second alternating current supplied from the driving circuit, to obtain a second result, and the integrated circuit, in operation, derives a position of the indicator based one the first result and the second result.

According to the present disclosure, alternating magnetic fields can be simultaneously sent from the plurality of sending coil conductors in each of the first period and the second period, and a signal detected by the detection coils can be separated for each of the sending coil conductors. Accordingly, improvement of a signal to noise ratio of a pen signal received by a sensor controller is achievable without lowering frequency of position detection and without increasing a circuit scale of the sensor controller.

### BRIEF DESCRIPTION OF THE SEVERAL VIEWS OF THE DRAWINGS

FIG. 1 is a diagram illustrating a configuration of a position detection system according to a first embodiment of the present disclosure;

FIG. 2 is a diagram illustrating an internal configuration of a switch unit illustrated in FIG. 1;

FIG. 3 is a diagram illustrating a state of the switch unit while a sensor controller is detecting a position of an electromagnetic resonance pen;

FIG. 4 is a diagram illustrating a state of the switch unit while the sensor controller is detecting the position of the electromagnetic resonance pen;

FIG. 5 is a diagram illustrating a state of the switch unit while the sensor controller is detecting the position of the electromagnetic resonance pen;

FIG. 6 is a diagram explaining a reception signal supplied from an operational amplifier to the sensor controller;

FIG. 7 is a flowchart illustrating an overall flow executed by the sensor controller to detect the position of the electromagnetic resonance pen;

FIG. 8 is a flowchart illustrating an overall flow executed by the sensor controller to detect the position of the electromagnetic resonance pen;

FIG. 9 is a flowchart illustrating an overall flow executed by the sensor controller to detect the position of the electromagnetic resonance pen;

FIG. 10 is a diagram illustrating the reception signal according to a first comparative example of the first embodiment of the present disclosure;

FIG. 11 is a diagram illustrating the reception signal according to a second comparative example of the first embodiment of the present disclosure;

FIG. 12 is a diagram illustrating a result of simulation of a level (a level after separation in a case of separate acquisition) of a pen signal received in accordance with an alternating magnetic field sent from each of loop coils located near a loop coil on which the electromagnetic resonance pen is positioned;

FIG. 13 is a diagram illustrating a configuration of the position detection system according to a second embodiment of the present disclosure;

FIG. 14 is a diagram illustrating an internal configuration of the switch unit illustrated in FIG. 13;

FIG. 15 is a diagram illustrating a state of the switch unit while the sensor controller is detecting the position of the electromagnetic resonance pen;

FIG. 16 is a diagram illustrating a state of the switch unit while the sensor controller is detecting the position of the electromagnetic resonance pen;

FIG. 17 is a diagram illustrating a state of the switch unit while the sensor controller is detecting the position of the electromagnetic resonance pen;

FIG. 18 is a diagram illustrating a configuration of the position detection system 1 according to a third embodiment of the present disclosure;

FIG. 19 is a diagram illustrating an internal configuration of the switch unit illustrated in FIG. 18;

FIG. 20 is a diagram illustrating a state of the switch unit while the sensor controller is detecting a position of a finger;

FIG. 21 is a diagram illustrating a state of the switch unit while the sensor controller is detecting the position of the electromagnetic resonance pen;

FIG. 22 is a diagram illustrating a state of the switch unit while the sensor controller is detecting the position of the electromagnetic resonance pen;

FIG. 23 is a diagram illustrating a state of the switch unit while the sensor controller is detecting the position of the electromagnetic resonance pen;

FIGS. 24A through 24C are diagrams schematically illustrating methods for supplying alternating current in FIGS. 21 through 23, respectively, while FIGS. 24D through 24F are diagrams illustrating equivalent circuits in a case where different kinds of alternating current are supplied to six linear electrodes by the methods illustrated in FIGS. 24A through 24C, respectively;

FIG. 25 is a flowchart illustrating an overall flow executed by the sensor controller to detect the position of the electromagnetic resonance pen;

FIG. 26 is a flowchart illustrating an overall flow executed by the sensor controller to detect the position of the electromagnetic resonance pen;

FIG. 27 is a flowchart illustrating an overall flow executed by the sensor controller to detect the position of the electromagnetic resonance pen;

FIGS. 28A through 28C are diagrams illustrating reception signals input to the sensor controller when the electromagnetic resonance pen is located above a pseudo loop coil in connection modes of FIGS. 24A through 24C, respectively, while FIGS. 28D through 28F are diagrams illustrating levels obtained when the reception signals illustrated in FIGS. 28A through 28C are acquired, respectively;

FIGS. 29A and 29B are diagrams illustrating angles θ and φ each indicating a tilt of the electromagnetic resonance pen;

FIGS. 30A through 30C are diagrams illustrating levels of pen signals acquired when (θ, φ)=(0, 0);

FIGS. 31A through 31C are diagrams illustrating levels of pen signals acquired when (θ, φ)=(60, 0);

FIGS. 32A through 32C are diagrams illustrating levels of pen signals acquired when (θ, φ)=(60, 90);

FIGS. 33A through 33C are diagrams illustrating levels of pen signals acquired when (θ, φ)=(60, 180);

FIG. 34A is a diagram illustrating a method performed by the position detection system according to the third embodiment of the present disclosure to select linear electrodes, while FIG. 34B is a diagram illustrating a method performed by the position detection system according to a fourth embodiment of the present disclosure to select the linear electrodes;

FIGS. 35A, 35B, and 35C are diagrams illustrating methods for selecting the linear electrodes in CDM1, CDM3, and CDM7, respectively, while FIGS. 35D, 35E, and 35F are diagrams illustrating levels of pen signals (levels after restoring calculation when restoring calculation is carried out) obtained by CDM1, CDM3, and CDM7, respectively;

FIGS. 36A and 36B are diagrams illustrating levels of pen signals acquired by use of CDM1, CDM3, and CDM7, while FIG. 36C is a diagram formed by plotting measured values and theoretical values for peak values of levels of pen signals for each of CDM1, CDM3, and CDM7;

FIGS. 37A through 37C are diagrams illustrating levels of pen signals acquired when (θ, φ)=(0, 0);

FIGS. 38A through 38C are diagrams illustrating levels of pen signals acquired when (θ, φ)=(60, 0);

FIGS. 39A through 39C are diagrams illustrating levels of pen signals acquired when (θ, φ)=(60, 90);

FIGS. 40A through 40C are diagrams illustrating levels of pen signals acquired when (θ, φ)=(60, 180); and

FIGS. 41A, 41B, and 41C are diagrams illustrating sending of an alternating magnetic field from a pseudo loop coil by different methods, while FIGS. 41D, 41E, and 41F are diagrams illustrating levels of pen signals obtained when an alternating magnetic field is sent from the pseudo loop coil by the methods illustrated in FIGS. 41A, 41B, and 41C, respectively.

### DETAILED DESCRIPTION

Embodiments of the present disclosure will hereinafter be described in detail with reference to the accompanying drawings.

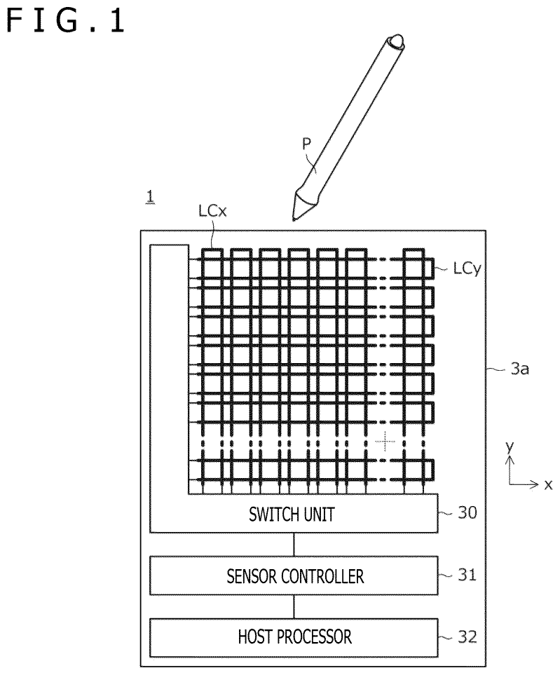

FIG. 1 is a diagram illustrating a configuration of a position detection system 1 according to a first embodiment of the present disclosure. As illustrated in this figure, the position detection system 1 includes an electromagnetic resonance pen P and a position detection device 3. Among these components, the electromagnetic resonance pen P is a pen allowing position detection using an EMR method, and includes a resonance circuit containing coils and capacitors inside.

The position detection device 3 is a device handling detection of a position of the electromagnetic resonance pen P with use of the EMR method, and includes a plurality of loop coils LCx (detection coils), a plurality of loop coils LCy (sending coil conductors), a switch unit 30, a sensor controller 31, and a host processor 32. The position detection device 3 is a tablet-type device or a laptop computer which has a display face also functioning as a touch face in a typical example, but may be a digitizer or the like having no display face.

Each of x and y directions illustrated in the figure is a direction within a touch face, and cross each other at right angles. Each of the plurality of loop coils LCx is configured to extend in the y direction (first direction) and arranged side by side in the x direction (second direction). Meanwhile, each of the plurality of loop coils LCy is configured to extend in the x direction and arranged side by side in the y direction. Both ends of each of the loop coils LCx and both ends of the loop coils LCy are connected to the switch unit 30.

The switch unit 30 is an assembly of a plurality of switches for switching connection between the sensor controller 31 and the plurality of loop coils LCx and loop coils LCy. The switch unit 30 may be provided within a dedicated circuit board or integrated circuit, or may be provided within an integrated circuit provided for the sensor controller 31. Switching of the switch unit 30 is controlled by the sensor controller 31.

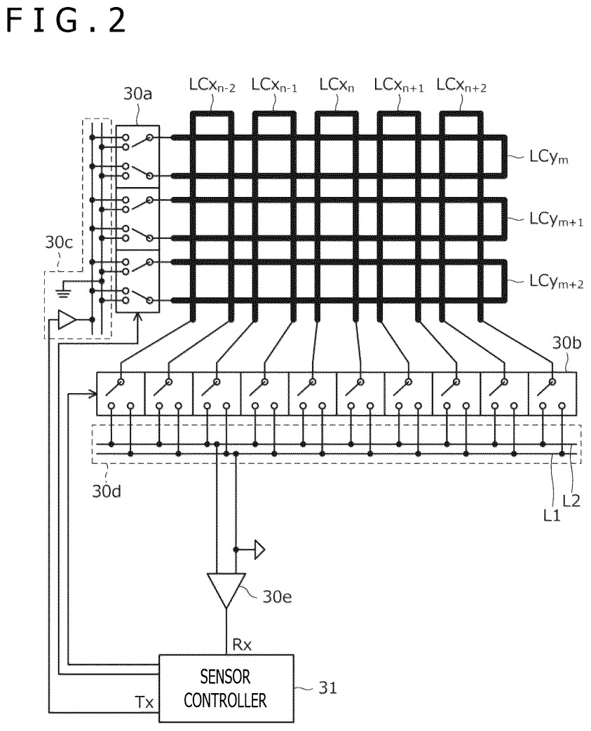

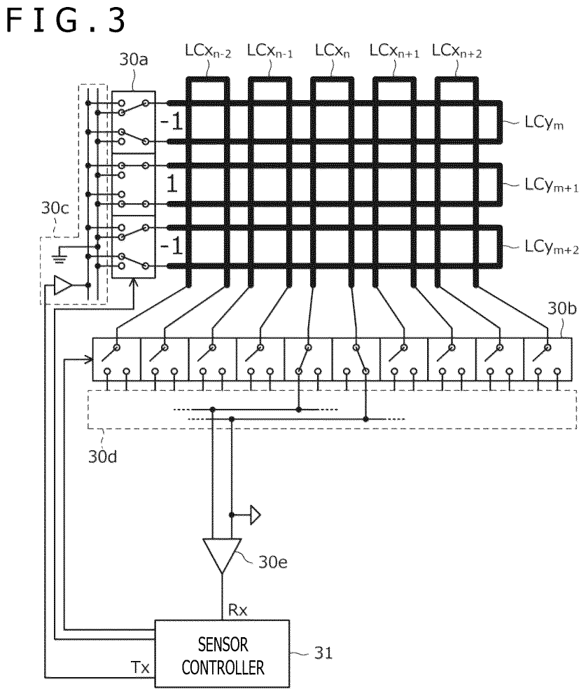

FIG. 2 is a diagram illustrating an internal configuration of the switch unit 30. For the purpose of simplification, only five loop coils LCx and only three loop coils LCy (loop coils LCXₙ₋₂ through LCXₙ₊₂, loop coils LCyₘ through LCyₘ₊₂) are illustrated in the figure. This also applies to FIGS. 3 through 5 referred to below. As illustrated in FIG. 2, the switch unit 30 includes two types of switches 30a and 30b, a driving circuit 30c, a wiring unit 30d, and an operational amplifier 30e.

The switch 30a is a component for supplying alternating current Tx and ground potential to the loop coils LCy to generate alternating magnetic fields on the touch face, and includes output pins provided such that one output pin corresponds to one end of the corresponding loop coil LCy, and input pins provided such that two input pins correspond to the corresponding one output pin. Alternating current is supplied from the driving circuit 30c to one of the two input pins, while ground potential is supplied from the driving circuit 30c to the other input pin. The switch 30a has a function of connecting each of the output pins to either one of the corresponding two input pins under control by the sensor controller 31.

The driving circuit 30c is a circuit for generating alternating current according to the alternating current Tx supplied from the sensor controller 31, and supplying the generated alternating current to each of the loop coils LCy via the switch 30a. The processing performed by the driving circuit 30c to generate alternating current according to the alternating current Tx is typically processing for amplifying the alternating current Tx. The driving circuit 30c also has a function of supplying ground potential to each of the loop coils LCy via the switch 30a. The driving circuit 30c supplies generated common alternating current to one of the two input pins of each of the loop coils LCy within the switch 30a, and supplies common ground potential to the other of the two input pins of each of the loop coils LCy within the switch 30a.

Each of the switch 30b and the wiring unit 30d is a component for supplying a pen signal received by each of the loop coils LCx (a signal indicated by an alternating magnetic field generated by the electromagnetic resonance pen P in accordance with an alternating magnetic field generated by each of the loop coils LCy) to the operational amplifier 30e. The switch 30b includes input pins provided such that one input pin corresponds to one end of the corresponding loop coil LCx and output pins provided such that four output pins correspond to the one corresponding input pin. The switch 30b has a function of connecting each of the input pins to any one of the corresponding four output pins under control by the sensor controller 31.

The wiring unit 30d includes two wires L1 and L2. The wire L1 of these wires is grounded. The two output pins included in the switch 30b for each of the input pins are pins provided in a manner corresponding to the foregoing two wires L1 and L2, and are connected to the corresponding wires.

The operational amplifier 30e is a circuit for generating a reception signal Rx by amplifying a voltage difference between an input terminal and a ground terminal, and constitutes a circuit for receiving pen signals in cooperation with the sensor controller 31. The input terminal of the operational amplifier 30e is connected to the wire L2 of the wiring unit 30d. Accordingly, the reception signal Rx is a signal present in the wire L2 and amplified. The reception signal Rx generated by the operational amplifier 30e is supplied to the sensor controller 31. A differential amplifier which generates the reception signal Rx by amplifying a voltage difference between the wire L2 and the wire L1 may be employed in place of the operational amplifier 30e.

The description will continue again with reference to FIG. 1. The sensor controller 31 is an integrated circuit which has a function of detecting a position of the electromagnetic resonance pen P within the touch face by using the EMR method. The sensor controller 31 also has a function of demodulating a pen signal transmitted from the electromagnetic resonance pen P to acquire data transmitted from the electromagnetic resonance pen P. The sensor controller 31 is configured to sequentially supply the detected position and the acquired data to the host processor 32.

The host processor 32 performs such processes as moving a cursor displayed on the display face and generating stroke data indicating a trajectory of the electromagnetic resonance pen P within the touch face, by using the position and the data supplied from the sensor controller 31. Concerning the stroke data in these processes, the host processor 32 also performs such processes as a process for rendering and displaying the generated stroke data, a process for generating and recording digital ink containing the generated stroke data, and a process for transmitting the generated digital ink to an external device in accordance with an instruction from a user.

In one or more implementations, the sensor controller 31 is an integrated circuit that includes at least one processor and at least one memory storing instructions that, when executed by the at least one processor, cause the integrated circuit to perform the acts of the sensor controller 31 described herein. A specific process performed by the sensor controller 31 for detecting a position of the electromagnetic resonance pen P will hereinafter be described with reference to FIGS. 3 through 5.

Each of FIGS. 3 through 5 is a diagram illustrating a state of the switch unit 30 while the sensor controller 31 is detecting the position of the electromagnetic resonance pen P. The sensor controller 31 performs such a process as to sequentially select respective sets each constituted by three adjacent loop coils LCy during connection between any one of the loop coils LCx (loop coil LCxₙ in FIGS. 3 through 5) and the operational amplifier 30e by control of the switch 30b, and connect the three loop coils LCy constituting the selected set to the driving circuit 30c in three connection modes having different connection polarities for each selection of the set of the loop coils LCy by controlling the switch 30a.

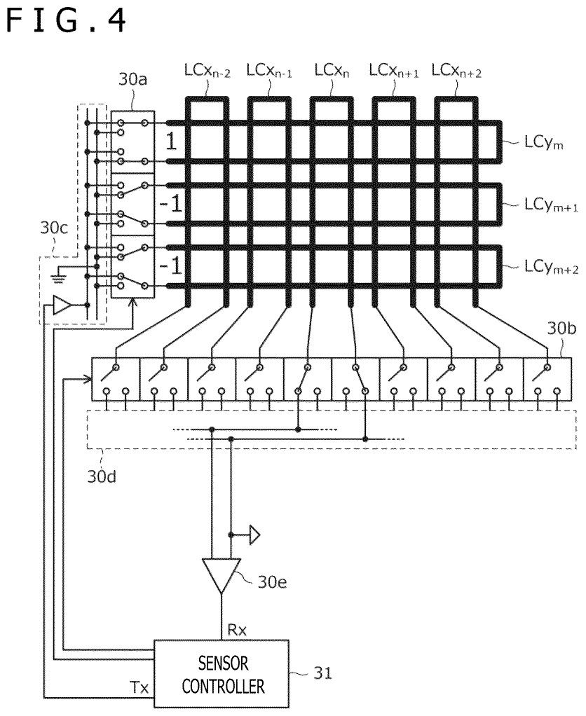

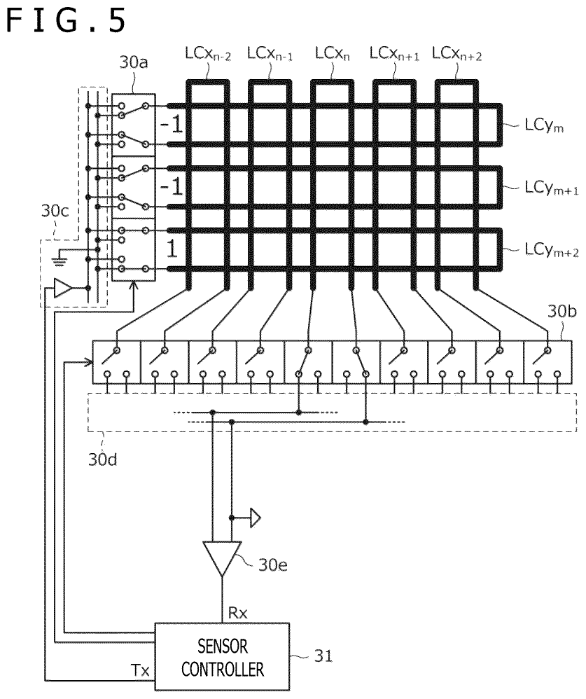

Each of FIGS. 3 through 5 illustrates connection in the three connection modes described above. Specifically, in the example of FIG. 3, as viewed from the driving circuit 30c, the loop coil LCyₘ is connected anticlockwise (expressed as “−1” in the figure), the loop coil LCyₘ₊₁ is connected clockwise (expressed as “1” in the figure), and finally the loop coil LCyₘ₊₂ is connected anticlockwise. Meanwhile, in the example of FIG. 4, as viewed from the driving circuit 30c, the loop coil LCyₘ is connected clockwise, the loop coil LCyₘ₊₁ is connected anticlockwise, and the loop coil LCyₘ₊₂ is connected anticlockwise. In the example of FIG. 5, as viewed from the driving circuit 30c, the loop coil LCyₘ is connected anticlockwise, the loop coil LCyₘ₊₁ is connected anticlockwise, and finally the loop coil LCyₘ₊₂ is connected clockwise.

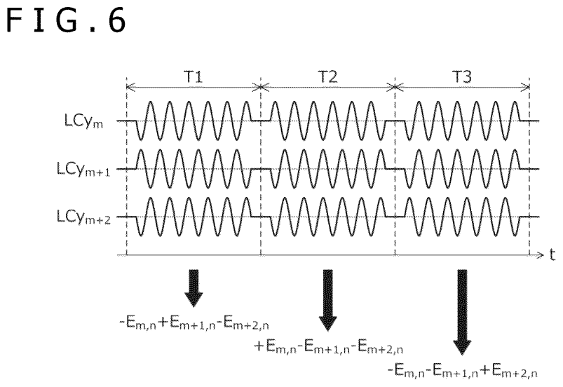

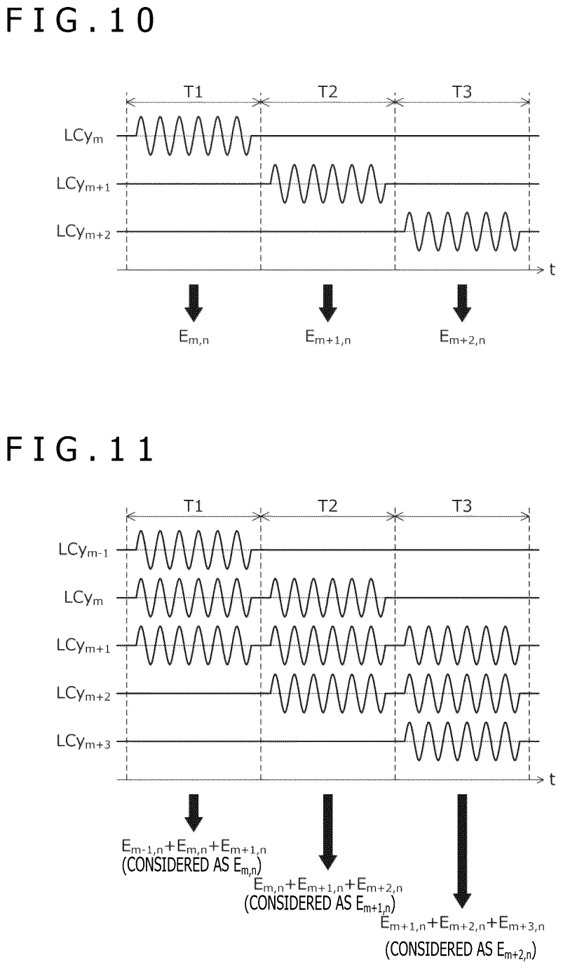

FIG. 6 is a diagram explaining the reception signal Rx supplied from the operational amplifier 30e to the sensor controller 31 as a result of the foregoing connection. Pen signal detection periods T1 through T3 (first through third periods) illustrated in the figure correspond to the connection states in FIGS. 3 through 5, respectively. While a sending time of an alternating magnetic field is provided in a first half of each of the pen signal detection periods in actual situations, this sending time is not indicated in FIG. 6. Moreover, while the reception signal Rx attenuates with elapse of time in actual situations, this attenuation is not expressed in FIG. 6 for easy understanding. These also apply to FIGS. 10 and 11 referred to below.

As can be understood from FIG. 6, the alternating magnetic field sent during the pen signal detection period T1 for the loop coil LCyₘ₊₁ has a phase opposite to those phases of the loop coil LCyₘ and LCyₘ₊₂. This state is produced by the clockwise connection of the loop coil LCyₘ₊₁ and the anticlockwise connection of the loop coils LCyₘ and LCyₘ₊₂ as described above. Accordingly, assuming that levels of the pen signal received by the loop coil Lcxₙ according to the alternating magnetic fields sent from the respective loop coils LCyₘ through LCyₘ₊₂ are expressed as levels E_{m,n} through E_{m+2,n}, respectively, the reception signal Rx (result value) supplied from the operational amplifier 30e to the sensor controller 31 during the pen signal detection period T1 is expressed as −E_{m,n}+E_{m+1,n}−E_{m+2,n} as illustrated in FIG. 6. Similarly, the reception signals Rx supplied in the pen signal detection periods T2 and T3 are expressed as +E_{m,n}−E_{m+1,n}−E_{m+2,n} and −E_{m,n}−E_{m+1,n}+E_{m+2,n}, respectively.

A vector d_{LC} expressed as the following equation (1) indicates the reception signal Rx received during each of the pen signal detection periods T1 through T3 in a vector format. As indicated in a final line in equation (1), the vector d_{LC} can be deformed into a form of a product of a 3×3 matrix F expressing a connection polarity in the corresponding pen signal detection period, and a vector expressing the corresponding one of the levels E_{m,n} through E_{m+2,n}. Note that the matrix F included in equation (1) has 3×3 Walsh codes.

$$\begin{matrix}Math . 1 & \\ {d}_{LC} = ( \begin{matrix}- {E}_{m , n} + {E}_{m + 1 , n} - {E}_{m + 2 , n} \\ + {E}_{m , n} - {E}_{m + 1 , n} - {E}_{m + 2 , n} \\ - {E}_{m , n} - {E}_{m + 1 , n} + {E}_{m + 2 , n}\end{matrix} ) = ( \begin{matrix}- 1 & 1 & - 1 \\ 1 & - 1 & - 1 \\ - 1 & - 1 & 1\end{matrix} ) ( \begin{matrix}{E}_{m , n} \\ {E}_{m + 1 , n} \\ {E}_{m + 2 , n}\end{matrix} ) = F ( \begin{matrix}{E}_{m , n} \\ {E}_{m + 1 , n} \\ {E}_{m + 2 , n}\end{matrix} ) & ( 1 )\end{matrix}$$

The sensor controller 31 separately acquires the levels E_{m,n} through E_{m+2,n} by calculating the left side of the following equation (2) for the vector d_{LC}. Note that a matrix F⁻¹ included in equation (2) is an inverse matrix of the matrix F. Accordingly, the calculation indicated by the left side of equation (2) is restoring calculation corresponding to the connection polarity of the loop coil LCx in each of the connection modes described above. As also indicated in equation (2), an identity matrix I is obtained by multiplying the matrix F by matrix F⁻¹. Accordingly, by carrying out this restoring calculation, the sensor controller 31 can separately acquire the levels E_{m,n} to E_{m+2,n} of the pen signal received by the loop coil LCXₙ according to the alternating magnetic fields sent from the respective loop coils LCyₘ through LCyₘ₊₂ as indicated in the right side of equation (2).

$$\begin{matrix}Math . 2 & \\ {F}^{- 1} {d}_{LC} = {F}^{- 1} F ( \begin{matrix}{E}_{m , n} \\ {E}_{m + 1 , n} \\ {E}_{m + 2 , n}\end{matrix} ) = I ( \begin{matrix}{E}_{m , n} \\ {E}_{m + 1 , n} \\ {E}_{m + 2 , n}\end{matrix} ) = ( \begin{matrix}{E}_{m , n} \\ {E}_{m + 1 , n} \\ {E}_{m + 2 , n}\end{matrix} ) & ( 2 )\end{matrix}$$

The sensor controller 31 separately acquires levels of the pen signal received by the loop coil LCxₙ according to alternating magnetic fields respectively sent from a plurality of loop coils LCyₘ by executing calculation similar to equation (2) for each set of the loop coils LCy. The sensor controller 31 also acquires levels of the pen signal received by each of the plurality of loop coils LCx according to alternating magnetic fields respectively sent from the plurality of loop coils LCyₘ by executing similar calculation while changing the loop coil LCx designated to receive the pen signal. Thereafter, the sensor controller 31 derives a position of the electromagnetic resonance pen P in reference to distribution of the levels of the pen signal thus acquired within the touch face. Specifically, a position corresponding to a peak of the distribution is derived as the position of the electromagnetic resonance pen P.

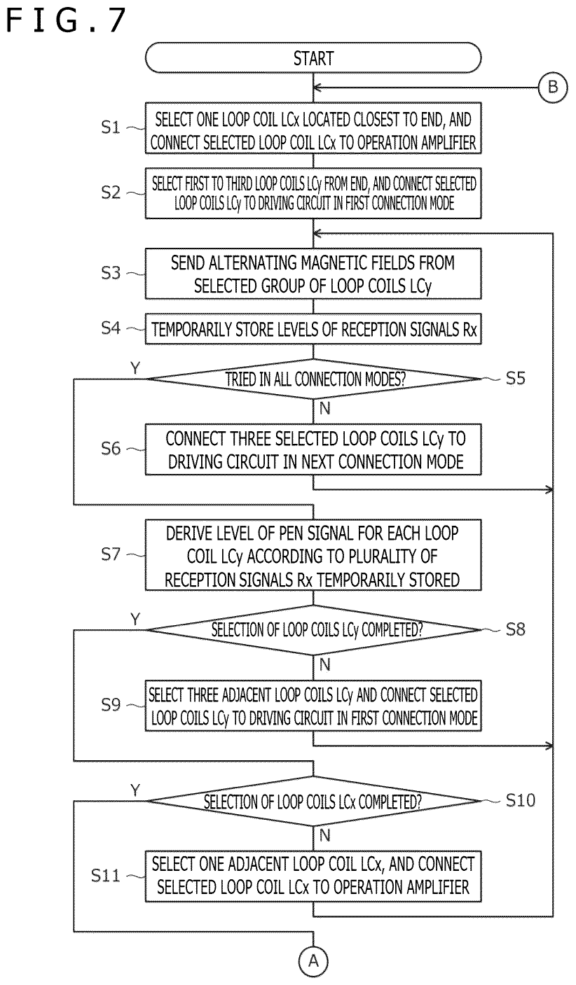

Each of FIGS. 7 through 9 is a flowchart illustrating an overall flow executed by the sensor controller 31 according to the present embodiment to detect the position of the electromagnetic resonance pen P. Described with reference to FIG. 7 first, the sensor controller 31, before detection of the electromagnetic resonance pen P, selects the one loop coil LCx located closest to the end and connects the selected loop coil LCx to the operational amplifier 30e (step S1), and also selects the first through third loop coils LCy from the end and connects the selected three loop coils LCy to the driving circuit 30c in the first connection mode (e.g., the connection mode illustrated in FIG. 3) (step S2).

Next, the sensor controller 31 starts sending of alternating magnetic fields from the selected group of the loop coils LCy (step S3). Specifically, the sensor controller 31 starts supply of alternating current Tx to the driving circuit 30c. With the start of this supply, a flow of alternating current is generated either anticlockwise or clockwise in each of the three loop coils LCy. As a result, an alternating magnetic field is sent in a manner corresponding to the direction of the alternating current from each of the three loop coils LCy. Thereafter, the sensor controller 31 temporarily stores levels of the reception signal Rx output from the operational amplifier 30e according to the alternating magnetic fields sent in step S3 (step S4).

Subsequently, the sensor controller 31 determines whether or not the processing in steps S3 and S4 has been tried in all of the connection modes (step S5). Specifically, the sensor controller 31 determines whether or not the processing in steps S3 and S4 has been tried for all of the three connection modes illustrated in FIGS. 3 through 5. The sensor controller 31 determining that the trials have not yet been completed connects the selected three loop coils LCy to the driving circuit 30c in the subsequent connection mode by controlling the switch 30a (e.g., the connection mode subsequent to the connection mode illustrated in FIG. 3 is the connection mode illustrated in FIG. 4, and the connection mode subsequent to the connection mode illustrated in FIG. 4 is the connection mode illustrated in FIG. 5) (step S6), and then returns to step S3.

On the other hand, the sensor controller 31 determining that the trials have been completed in step S5 derives a level of the pen signal for each of the loop coils LCy according to a plurality of levels of the reception signal Rx temporarily stored by a plurality of times of the trial in step S4 (step S7). Specifically, the foregoing calculation for multiplying the vector d_{LC} by the inverse matrix F⁻¹ of the matrix F (restoring calculation) is carried out.

Subsequently, the sensor controller 31 determines whether or not selection of all of the loop coils LCy has been completed (step S8). If determining that selection of all of the loop coils LCy has not been completed yet, the sensor controller 31 selects the three loop coils LCy adjacent to the three loop coils LCy previously selected (selected in step S2 or S9), connects the adjacent three loop coils LCy to the driving circuit 30c in the first connection mode (e.g., the connection mode illustrated in FIG. 3) by controlling the switch 30a (step S9), and then returns to step S3. On the other hand, if determining that the selection has been completed in step S8, the sensor controller 31 determines whether or not selection of all of the loop coils LCx has been completed (step S10). If determining that this selection has not been completed yet, the sensor controller 31 selects the one loop coil LCx adjacent to the one loop coil LCx previously selected (selected in step S1 or S11), connects the selected one loop coil LCx to the operational amplifier 30e (step S11), and returns to step S3.

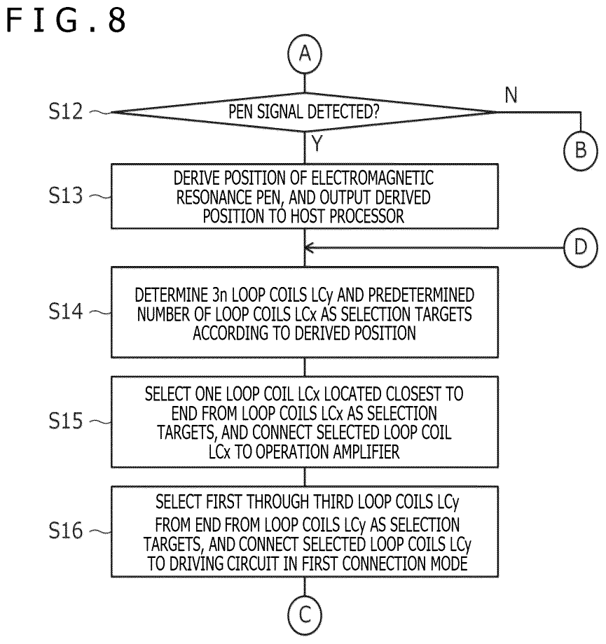

The sensor controller 31 determining that the selection has been completed in step S10 determines whether or not any pen signal has been detected, in reference to the levels of the pen signal obtained by repeating step S7 for each combination of the loop coils LCy and the loop coil LCx (step S12 in FIG. 8). In one example, a result of this determination is positive for a level exceeding a predetermined value, and is negative for other cases.

The sensor controller 31 determining that no pen signal has been detected in step S12 returns to step S1 in FIG. 7, and continues processing. On the other hand, the sensor controller 31 determining that a pen signal has been detected derives a position of the electromagnetic resonance pen P, according to the levels of the pen signal derived in step S7 in FIG. 7 for each combination of the loop coils LCy and the loop coil LCx, and outputs the derived position to the host processor 32 (step S13).

Next, the sensor controller 31 determines, as selection targets, the 3n loop coils Lcy (n: natural number, typically n=1; note that 3n is a number smaller than the total number of the loop coils LCy), and a predetermined number (a number smaller than the total number of the loop coils LCx, typically 3 or 4) of loop coils LCx according to the position derived in step S13 (a position derived in previous step S27 in a case of transition from step S27 described later) (step S14).

Subsequently, the sensor controller 31 connects the loop coil LCx located closest to the end from the loop coils LCx corresponding to the selection targets, and connects the selected loop coil LCx to the operational amplifier 30e (step S15). Thereafter, the sensor controller 31 selects the first through third loop coils LCy from the end from the loop coils LCy corresponding to the selection targets, and connects the selected three loop coils LCy to the driving circuit 30c in the first connection mode (e.g., the connection mode illustrated in FIG. 3) by controlling the switch 30a (step S16).

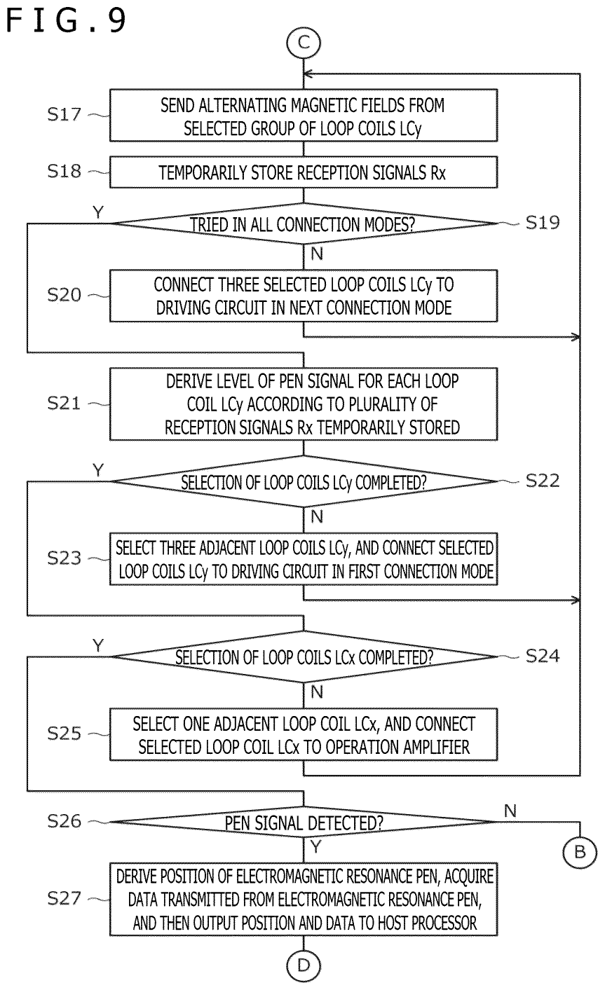

Described with reference to FIG. 9, the sensor controller 31 subsequently performs processing similar to the processing in steps S3 through S12 in FIGS. 7 and 8 (steps S17 through S26). Note that the processing here is different from the processing in steps S3 through S12 in that step S18 also stores a series of digital values (obtained by sampling) constituting the reception signal Rx unlike step S4 which temporarily stores only the levels of the reception signal Rx, that step S22 determines whether or not selection of all of the loop coils LCy determined as the selection targets in step S14 has been completed unlike step S8 which determines whether or not selection of all of the loop coils LCy has been completed, and that step S24 determines whether or not selection of all of the loop coils LCx determined as the selection targets in step S14 has been completed unlike step S10 which determines whether or not selection of all of the loop coils LCx has been completed.

The sensor controller 31 determining that the pen signal has been detected in step 26 derives a position of the electromagnetic resonance pen P, acquires data transmitted from the electromagnetic resonance pen P, and then outputs those position and data to the host processor 32 (step S27). Specifically, the sensor controller 31 derives the position of the electromagnetic resonance pen P, according to the levels of the pen signal derived for each combination of the loop coils LCy and the loop coil LCx in step S21. Moreover, the sensor controller 31 demodulates the series of digital values stored in step S18 for the combination of the loop coils LCy and the loop coil LCx located closest to the derived position, to acquire the data transmitted from the electromagnetic resonance pen P. After completion of step S27, the sensor controller 31 returns to step S14 and continues processing.

According to the position detection method of the present embodiment, a signal to noise ratio of a pen signal received by the sensor controller 31 can improve without lowering frequency of position detection and without increasing a circuit scale of the sensor controller 31. Advantageous effects of this method will hereinafter be described in detail in comparison with a comparative example which sends alternating magnetic fields by a method different from the method of the present embodiment.

FIG. 10 is a diagram explaining the reception signal Rx in a first comparative example. The sensor controller 31 in the present comparative example sends an alternating magnetic field from only the one loop coil LCy in each of the pen signal detection periods. In this case, a level of a pen signal received according to the alternating magnetic field sent from the one loop coil LCy is obtained in each of the pen signal detection periods. Accordingly, the sensor controller 31 can acquire levels of the pen signal received according to the alternating magnetic fields sent from the respective loop coils LCy, without a necessity of performing the calculating operation described above.

FIG. 11 is a diagram explaining the reception signal Rx in a second comparative example. The sensor controller 31 in the present comparative example simultaneously sends alternating magnetic fields from the three adjacent loop coils LCy in each of the pen signal detection periods as in the present embodiment. However, the sensor controller 31 in the present comparative example connects all of the loop coils LCy to the driving circuit 30c in the same direction (clockwise or anticlockwise). In this case, levels of a pen signal received according to the alternating magnetic fields sent from the respective loop coils LCy are not separable from each other by the calculation described above. However, the sensor controller 31 can derive the position of the electromagnetic resonance pen P while regarding that the reception signal Rx obtained according to the alternating magnetic fields sent from the three loop coils LCy as the signal obtained in accordance with an alternating magnetic field sent from the loop coil LCy located at the center of the three loop coils LCy.

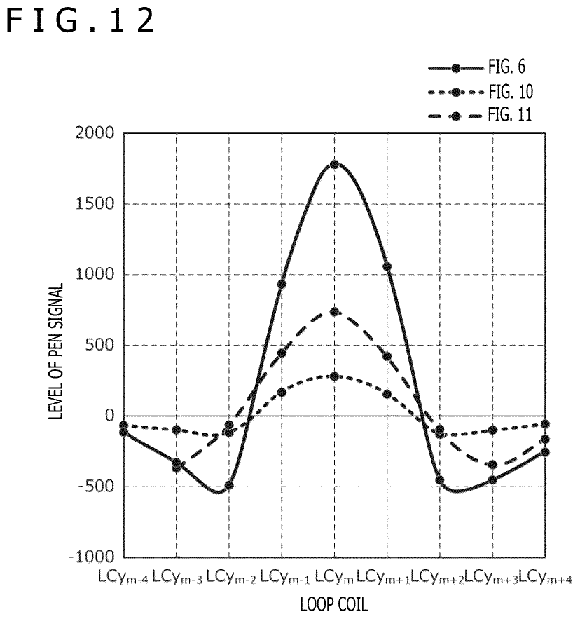

FIG. 12 is a diagram illustrating a result of simulation of levels (levels after separation in a case of separate acquisition) of a pen signal received in accordance with alternating magnetic fields sent from the respective loop coils LCyₘ located near the loop coil LCyₘ on which the electromagnetic resonance pen P is positioned. This figure presents respective results of the present embodiment (FIG. 6), the first comparative example (FIG. 10), and the second comparative example (FIG. 11). As can be seen from this figure, the position detection method according to the present embodiment can offer such an advantageous effect that reception levels of a pen signal considerably increase in comparison with the first and second comparative examples. This advantageous effect is produced because the pen signal detection period allowed for acquiring the pen signal according to alternating magnetic fields sent from the respective loop coils LCyₘ according to the position detection method of the present embodiment is three times longer than the pen signal detection period of each of the first and second comparative examples. Consider here the following fact already mentioned above. When the pen signal detection period for detecting a pen signal by the sensor controller 31 becomes N times longer, a received pen signal has an N-times higher level. Meanwhile, received noise has only an N^{1/2} higher level. Accordingly, the position detection method of the present embodiment is considered to improve the signal to noise ratio of the pen signal received by the sensor controller 31.

In addition, the position detection method according to the present embodiment can simultaneously receive a pen signal corresponding to a plurality of loop coils LCy by one receiving circuit in each of a plurality of pen signal detection periods, and separate the reception signal Rx into components of each of the loop coils LCy. In this case, a necessity of elongating the transmission period of the pen signals for improving the signal to noise ratio and a necessity of additionally providing reception circuits for parallelly receiving the pen signals by using a plurality of loop coils Lcx are both eliminated. Accordingly, the position detection method of the present embodiment is considered to improve the signal to noise ratio of the pen signals received by the sensor controller 31, without lowering frequency of position detection and without increasing the circuit scale of the sensor controller 31.

When the pen signal detection period for detecting a pen signal by the sensor controller 31 becomes N times longer, the received pen signal has an N-times higher level. Meanwhile, received noise has only an N^{1/2} higher level as described above. This point will be explained here in more detail.

Assuming that the reception signal Rx acquired in a kth pen signal detection period is expressed as Xₖ and that a variance of this signal is expressed as V(Xₖ), a variance V_{TOTAL} of a signal obtained by adding 1st to N reception signals X₁ through X_{N} acquired in first to Nth pen signal detection periods (hereinafter simply referred to as an “added signal”), based on additivity of variances, is expressed as a sum of variances of the reception signal Rx in the respective pen signal detection periods as presented in the following equation (3).

$$\begin{matrix}Math . 3 & \\ {V}_{TOTAL} = V ( {X}_{1} ) + V ( {X}_{2} ) + V ( {X}_{3} ) + ⋯ + V ( {X}_{N} ) & ( 3 )\end{matrix}$$

Focusing on only a noise component contained in the reception signal Rx, the variance V_{TOTAL} of the added signal is further expressed as the following equation (4) in consideration that the noise has the same value in all of the pen signal detection periods. Note that V and o are a variance and a standard deviation, respectively, in each of the pen signal detection periods.

$$\begin{matrix}Math . 4 & \\ {V}_{TOTAL} = V + V + V + ⋯ + V = N \cdot V = N \cdot {σ}^{2} & ( 4 )\end{matrix}$$

A quantity of noise appearing in the added signal is expressed by a standard deviation σ_{TOTAL} of the added signal. The foregoing standard deviation σ_{TOTAL} is expressed as the following equation (5) based on equation (4). It is hence understood why the level of noise still remains N^{1/2} times higher when the pen signal detection period of the sensor controller 31 for detecting a pen signal becomes N times longer.

$$Math . 5$$

$${σ}_{TOTAL} = \sqrt{{V}_{TOTAL}} = \sqrt{N} σ \qquad ( 5 )$$

As explained above, the position detection system 1 according to the present embodiment can improve a signal to noise ratio of a pen signal received by the sensor controller 31, without lowering frequency of position detection and without increasing the circuit scale of the sensor controller 31.

While described in the present embodiment has been the example where the matrix F included in equation (1) is a matrix expressed by 3×3 Walsh codes, a matrix expressed by codes other than Walsh codes, such as orthogonal variable spreading factor (OVSF) codes, maximal length (M)-sequence codes, and Baker codes, is also suited for the matrix F (i.e., the connection modes of the loop coils LCy for the respective pen signal detection periods are set such that the matrix F has these codes).

This point will be explained in a more generalized manner. In a case where alternating magnetic fields are simultaneously sent from the k loop coils LCy (i.e., in a case where the sensor controller 31 sequentially selects respective sets each constituted by the adjacent k loop coils LCy during connection of any one of the loop coils LCx to the operational amplifier 30e by control of the switch 30b, and connects the k loop coils LCy constituting the selected set to the driving circuit 30c in k connection modes having different connection polarities for each selection of the set of the loop coils LCy by controlling the switch 30a), the connection mode of the loop coils LCy in each of the pen signal detection periods can be determined according to the matrix F (k-row k-column matrix) as a coefficient matrix of simultaneous equations expressed as following equation (6) if the matrix F has a rank equivalent to k. In other words, if respective column vectors of the matrix F (a plurality of vectors each indicating a connection state of the corresponding loop coil LCy) have a linearly independent relation, the connection modes of the loop coils LCy in the respective pen signal detection periods can be determined according to the matrix F thus configured. This manner of determination is allowed because equation (6) has a solution in any of the cases.

$$Math . 6$$

$$F ( \begin{matrix}{E}_{m , n} \\ {E}_{m + 1 , n} \\ {E}_{m + 2 , n} \\ ⋮ \\ {E}_{m + k , n}\end{matrix} ) = {d}_{LC} \qquad ( 6 )$$

Each of elements included in the matrix F thus configured is not required to have a value of “−1” or “1.” In a case of K=2, for example, the matrix F expressed as each of equation (7) and equation (8) presented below has a rank equivalent to 2. Accordingly, the matrix F is available for determining the connection mode of the loop coils LCy in each of the pen signal detection periods. When the matrix F expressed as equation (8) is used, alternating current supplied from the driving circuit 30c to the loop coils LCy corresponding to an element “2” has a direction identical to and a level different from a direction and a level of alternating current supplied to the loop coils LCy corresponding to an element “1” (specifically, alternating current in an identical direction and at a twice higher level).

$$Math . 7$$

$$F = ( \begin{matrix}1 & 1 \\ 1 & - 1\end{matrix} ) \qquad ( 7 )$$

$$F = ( \begin{matrix}1 & 2 \\ 2 & 1\end{matrix} ) \qquad ( 8 )$$

In addition, while described in the present embodiment has been the example which performs restoring calculation using the inverse matrix F⁻¹ of the matrix F, the restoring calculation may be carried out using a matrix other than the inverse matrix. Described hereinafter will be an example of a restoring calculation which uses the matrix F without change as a matrix other than the inverse matrix of the matrix F in a case where the vector d_{LC} expressed as equation (1) has been obtained.

This example first derives a level of the reception signal Rx corresponding to a case where all of the columns of the matrix F are “1” by using the matrix F for restoration and levels −E_{m,n}+E_{m+1,n}−E_{m+2,n}, +E_{m,n}−E_{m+1,n}−E_{m+2,n}, and −E_{m,n}−E_{m+1,n}+E_{m+2,n} of the reception signal Rx in the pen signal detection periods T1 through T3. Specifically, a, b, and c are obtained by solving the simultaneous equations expressed as the following equation (9), and a+b+c is derived. It is sufficient if the level of the reception signal Rx corresponding to the case where all of the columns of the matrix F are “1” is derived in the manner described above. The level thus derived is +E_{m,n}+E_{m+1,n}+E_{m+2,n}.

$$Math . 8$$

$$( \begin{matrix}- 1 & 1 & - 1 \\ 1 & - 1 & - 1 \\ - 1 & - 1 & 1\end{matrix} ) ( \begin{matrix}a \\ b \\ c\end{matrix} ) = ( \begin{matrix}- {E}_{m , n} + {E}_{m + 1 , n} - {E}_{m + 2 , n} \\ + {E}_{m , n} - {E}_{m + 1 , n} - {E}_{m + 2 , n} \\ - {E}_{m , n} - {E}_{m + 1 , n} + {E}_{m + 2 , n}\end{matrix} ) \qquad ( 9 )$$

Subsequently, as expressed as following equation (10), a column having all elements of “1” is added to the head of the matrix F, and a row having a value of +E_{m,n}+E_{m+1,n}+E_{m+2,n} is added to the head of the vector d_{LC}. Thereafter, the vector d_{LC} is multiplied by the matrix F. In this manner, a result of linear (specifically, quadruple) amplification of a calculation result of equation (9) is obtained.

$$Math . 9$$

$$( \begin{matrix}1 & - 1 & 1 & - 1 \\ 1 & 1 & - 1 & - 1 \\ 1 & - 1 & - 1 & 1\end{matrix} ) ( \begin{matrix}+ {E}_{m , n} + {E}_{m + 1 , n} + {E}_{m + 2 , n} \\ - {E}_{m , n} + {E}_{m + 1 , n} - {E}_{m + 2 , n} \\ + {E}_{m , n} - {E}_{m + 1 , n} - {E}_{m + 2 , n} \\ - {E}_{m , n} - {E}_{m + 1 , n} + {E}_{m + 2 , n}\end{matrix} ) = 4 ( \begin{matrix}{E}_{m , n} \\ {E}_{m + 1 , n} \\ {E}_{m + 2 , n}\end{matrix} ) \qquad ( 10 )$$

As described above, in the case of the restoring calculation using a matrix other than the inverse matrix F⁻¹ of the matrix F, the levels E_{m,n} to E_{m+2,n+1} can be separately acquired as in the restoring calculation using the inverse matrix F⁻¹ of the matrix F, even with the necessity of deriving the level of the reception signal Rx corresponding to the case where all of the columns of the matrix F are “1.”

In addition, concerning the result obtained in equation (10) by quadruple amplification of the calculation result of equation (9), an increase in the calculation result in this manner contributes to improvement of accuracy of calculation in the following stages, and is hence considered to be preferable. This applies to the case of the restoring calculation using the inverse matrix F⁻¹ of the matrix F. This point will be explained with use of a specific example.

The vector d_{LC} for the matrix F having 4×4 Walsh codes is expressed as the following equation (11). Note that a vector e is a vector indicating a level of a pen signal for the corresponding one of the four loop coils LCy.

$$Math . 10$$

$${d}_{LC} = Fe = ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} ) e \qquad ( 11 )$$

The inverse matrix F⁻¹ of the matrix F included in equation (11) is expressed as equation (12).

$$Math . 11$$

$${F}^{- 1} = \frac{1}{4} ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} ) \qquad ( 12 )$$

Accordingly, by multiplying the inverse matrix F⁻¹ by 4 as expressed in the following equation (13) for restoring calculation of the vector e, a vector having a quadrupled level of the original level of the vector e can be obtained even by the restoring calculation using the inverse matrix F⁻¹.

$$Math . 12$$

$$\begin{matrix}4 {F}^{- 1} {d}_{tx} = ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} ) {d}_{tx} \\ = ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} ) ( \begin{matrix}1 & 1 & 1 & 1 \\ 1 & - 1 & 1 & - 1 \\ 1 & 1 & - 1 & - 1 \\ 1 & - 1 & - 1 & 1\end{matrix} ) e \\ = 4 e\end{matrix} \qquad ( 13 )$$

The position detection system 1 according to a second embodiment of the present disclosure will be described next.

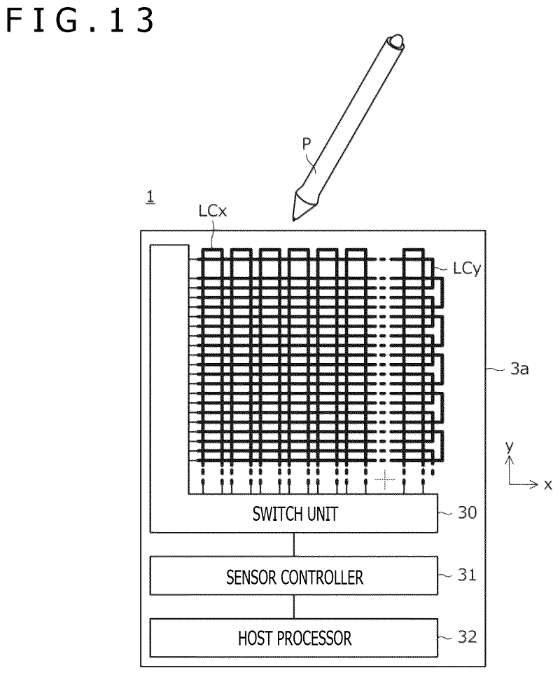

FIG. 13 is a diagram illustrating a configuration of the position detection system 1 according to the present embodiment. As can be understood from comparison between this figure and FIG. 1, the position detection system 1 according to the present embodiment is different from that of the first embodiment in that the adjacent loop coils LCy of each pair in the y direction are overlapped with each other. Other points of the position detection system 1 of the present embodiment are similar to the corresponding points of the position detection system 1 of the first embodiment. Accordingly, the description will continue while focus is placed on the different points from the position detection system 1 of the first embodiment.

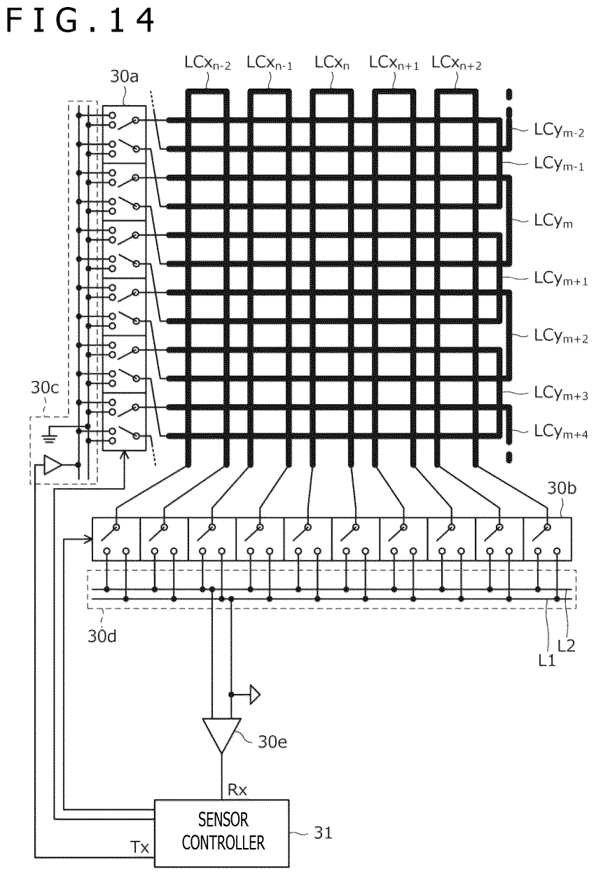

FIG. 14 is a diagram illustrating an internal configuration of the switch unit 30 disposed within the position detection device 3 constituting the position detection system 1 according to the second embodiment of the present disclosure. This figure illustrates only five loop coils LCx and seven loop coils LCy (loop coils LCXₙ₋₂ through LCxₙ₊₂, loop coils LCyₘ₋₂ through LCyₘ₊₄). This also applies to FIGS. 15 through 17 referred to below. As can be understood from comparison between FIG. 14 and FIG. 1, the internal configuration of the switch unit 30 according to the present embodiment is similar to the internal configuration of the switch unit 30 of the first embodiment other than the point that the adjacent loop coils LCy of each pair in the y direction are overlapped with each other.

Each of FIGS. 15 through 17 is a diagram illustrating a state of the switch unit 30 while the sensor controller 31 of the present embodiment is detecting a position of the electromagnetic resonance pen P. Similarly to the sensor controller 31 of the first embodiment, the sensor controller 31 according to the present embodiment performs such a process as to sequentially select respective sets each constituted by three adjacent loop coils LCy during connection between any one of the loop coils LCx (loop coil LCxₙ in FIGS. 15 through 17) and the operational amplifier 30e by control of the switch 30b, and connect the three loop coils LCy constituting the selected set to the driving circuit 30c in three connection modes having different connection polarities for each selection of the set of the loop coils LCy by controlling the switch 30a.

Specific details of the three connection modes are similar to the connection modes of the first embodiment. However, in the configuration of the present embodiment where the adjacent loop coils Lcy of each pair in the y direction are overlapped with each other, current paths cross each other between the two adjacent loop coils LCy. However, even in the presence of this crossing, the levels E_{m,n} to E_{m+2,n} can be separately acquired by the same restoring calculation as that of the first embodiment. Accordingly, as is the case with the first embodiment, the position detection method of the present embodiment is considered to improve a signal to noise ratio of pen signals received by the sensor controller 31, without lowering frequency of position detection and without increasing the circuit scale of the sensor controller 31.

The position detection system 1 according to a third embodiment of the present disclosure will be described next.

FIG. 18 is a diagram illustrating a configuration of the position detection system 1 according to the present embodiment. The position detection system 1 according to the present embodiment is different from the position detection system 1 of the second embodiment in that the position detection device 3 also handles detection of a position of a finger F by using a capacitance method, that the position detection device 3 has a plurality of linear electrodes EL instead of a plurality of loop coils LCy, and that the switch unit 30 has a different internal configuration. Other points of the position detection system 1 of the present embodiment are similar to the corresponding points of the position detection system 1 of the second embodiment. Accordingly, the description will continue hereinafter while focus is placed on the different points from the position detection system of the second embodiment.

Each of the plurality of linear electrodes EL is configured to extend in the x direction and arranged in one line in the y direction. Both ends of each of the linear electrodes EL are connected to the switch unit 30.

The switch unit 30 according to the present embodiment is an assembly of a plurality of switches for switching connection between the sensor controller 31 and the plurality of loop coils LCx and linear electrodes EL. As described in the first embodiment, the switch unit 30 may be provided within a dedicated circuit board or integrated circuit, or may be provided within an integrated circuit provided for the sensor controller 31. Switching of the switch unit 30 is controlled by the sensor controller 31.

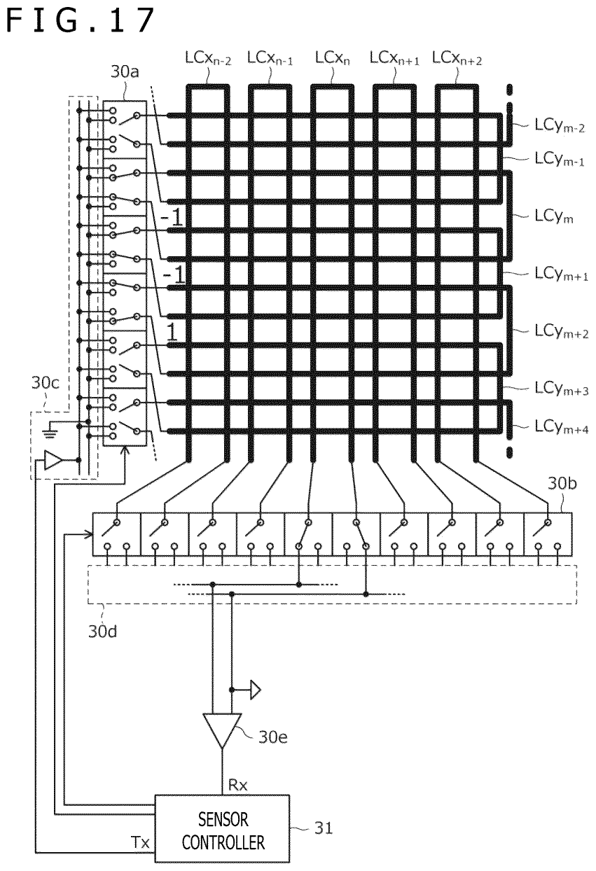

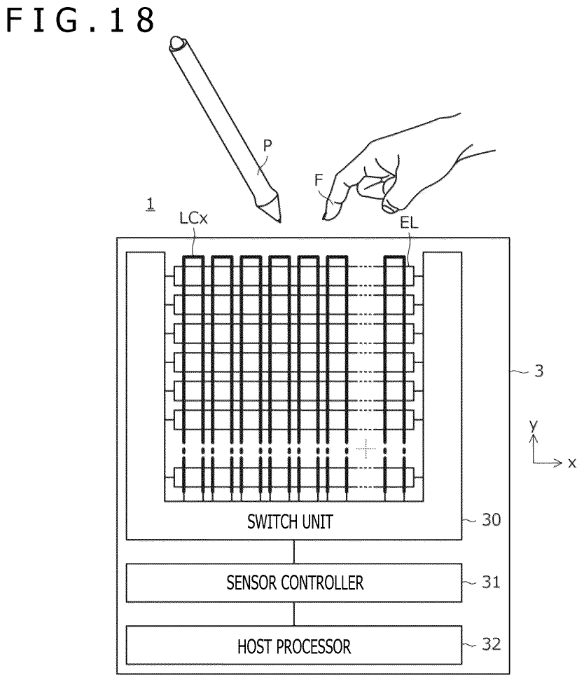

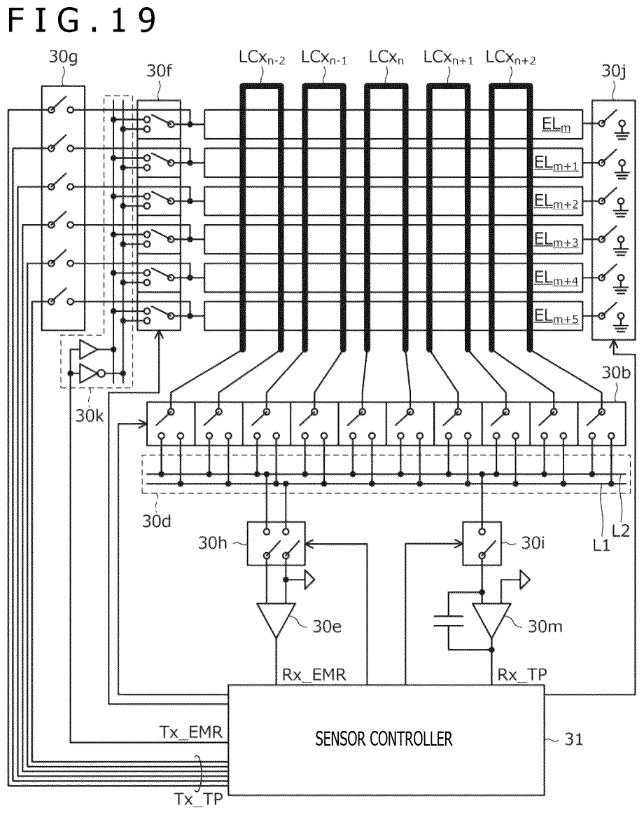

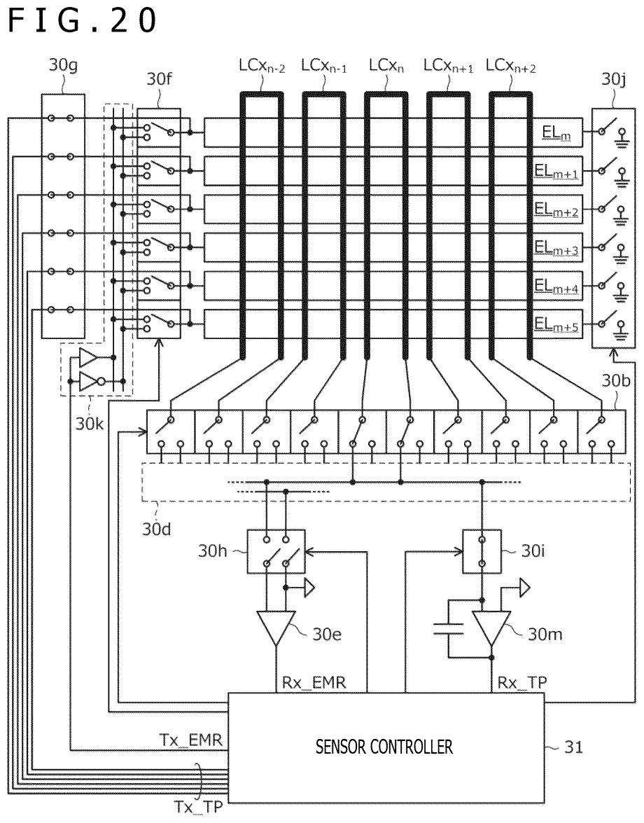

FIG. 19 is a diagram illustrating an internal configuration of the switch unit 30 according to the present embodiment. For the purpose of simplification, only five loop coils LCx and six linear electrodes EL (loop coils LCXₙ₋₂ through LCXₙ₊₂, linear electrodes ELₘ through ELₘ₊₅) are illustrated in the figure. This also applies to FIGS. 20 through 23 referred to below. As illustrated in FIG. 19, the switch unit 30 according to the present embodiment includes switches 30f through 30j, a driving circuit 30k, and an operational amplifier 30m in addition to the switch 30b, the wiring unit 30d, and the operational amplifier 30e which are the same components as those illustrated in FIG. 14. The switch 30a and the driving circuit 30c illustrated in FIG. 2 are not included in the switch unit 30 according to the present embodiment.

The switch 30f is a component for supplying alternating current Tx_EMR to the plurality of linear electrodes EL to generate alternating magnetic fields on the touch face, and includes output pins provided such that one output pin corresponds to the corresponding one linear electrode EL, and input pins provided such that two input pins correspond to the corresponding one output pin. Each of the output pins is connected to one end of the corresponding linear electrode EL in the x direction (longitudinal direction). The switch 30f has a function of connecting each of the input pins to any one of the output pins for each of the linear electrodes EL under control by the sensor controller 31.

The driving circuit 30k is a circuit for generating alternating current iA and alternating current is described below according to the alternating current Tx_EMR supplied from the sensor controller 31, and supplying the generated alternating current iA and alternating current i_{B} to each of the linear electrodes EL via the switch 30f. The driving circuit 30k is configured to supply the alternating current iA to one of the two input pins corresponding to each of the linear electrodes EL and supply the alternating current i_{B} to the other input pin.

For example, the alternating current iA is current generated by amplification of the alternating current Tx_EMR with use of a buffer circuit. Meanwhile, the alternating current i_{B} is current so generated as to satisfy such a relation that the alternating current i_{A} and the alternating current i_{B} have opposite phases of time derivatives. This relation is expressed as the following equation (14).

$$Math . 13$$

$$\frac{{di}_{A} ( t )}{dt} = - \frac{{di}_{B} ( t )}{dt} \qquad ( 14 )$$

The typical alternating current i_{B} satisfying the relation of equation (14) is expressed as the following equation (15). Note that A is any constant. In a case of A=0, the alternating current i_{B} is an inversion signal of the alternating current i_{A}. In this case, the alternating current i_{A} and the alternating current i_{B} have opposite signs. Meanwhile, when A is larger than a maximum value of the alternating current iA, the alternating current i_{A} and the alternating current i_{B} have the same sign but different levels. Note that the inversion signal of the alternating current i_{A} can be generated using an inverting buffer circuit, for example. FIG. 19 illustrates an example using this inverting buffer circuit.

$$Math . 14$$

$${i}_{B} ( t ) = - {i}_{A} ( t ) + A \qquad ( 15 )$$

It is preferable that potential at the other end of each of the linear electrodes EL receiving supply of the alternating current i_{A} and the alternating current i_{B} be central potential between potential generated at one end of the linear electrode EL receiving supply of the alternating current i_{A} and potential generated at one end of the linear electrode EL receiving supply of the alternating current i_{B}. When A=0, this potential is 0 (i.e., ground potential).

The switch 30g is a component for supplying a touch detection signal Tx_TP for detecting a position of the finger F to the plurality of linear electrodes EL, and includes sets each constituted by an input pin and an output pin and provided for each of the linear electrodes EL. The touch detection signal Tx_TP is supplied from the sensor controller 31 to each of the input pins. Each of the output pins is connected to one end of the corresponding linear electrode EL in the x direction (longitudinal direction). The switch 30g has a function of connecting each of the input pins to the corresponding output pin under control by the sensor controller 31.

The switch 30j is a component for switching a state of the other end of each of the linear electrodes EL in the x direction (longitudinal direction) between a state connected to the central potential described above and a floating state connected to none. FIG. 19 illustrates a case where the central potential described above is ground potential. In this case, the switch 30j includes a set of an input pin and a ground pin for each of the linear electrodes EL as illustrated in FIG. 19. The description will continue hereinafter on an assumption that the central potential described above is ground potential.

Each of the input pins of the switch 30j is connected to the other end of the corresponding linear electrode EL in the x direction (longitudinal direction). Meanwhile, each of the ground pins of the switch 30j is connected to a ground end to which the ground potential is supplied. The switch 30j is provided for the following reason. For detecting the position of the electromagnetic resonance pen P by the sensor controller 31, it is preferable that the other end of each of the linear electrodes EL in the x direction have ground potential as described above. However, for detecting the position of the finger F by the sensor controller 31, the other end of each of the linear electrodes EL in the x direction is required to be brought into the floating state. The switch 30j has a function of switching the connection state between each of the input pins and the corresponding ground pin under control by the sensor controller 31.

Each of the switches 30b, 30h, and 30i and the wiring unit 30d is a component for supplying a pen signal received by each of the loop coils LCx (a signal transmitted from the electromagnetic resonance pen P according to an alternating magnetic field) to the operational amplifier 30e and for supplying a touch detection signal Tx_TP received by each of the loop coils LCx to the operational amplifier 30m. Among these components, specific configurations of the switch 30b and the wiring unit 30d are similar to those of the first and second embodiments.

The switch 30h is a switch which connects the wire L2 to an input terminal of the operational amplifier 30e, and connects the wire L1 to a ground end, under control by the sensor controller 31. The switch 30i is a switch which connects the wire L2 to an input terminal of the operational amplifier 30m under control by the sensor controller 31. An off-state (not-connected state) is designated as an initial state for both the switches 30h and 30i.

The operational amplifier 30e is identical to the operational amplifier 30e described in the first embodiment. In the present embodiment, however, a signal generated by the operational amplifier 30e will be referred to as the reception signal Rx_EMR. The operational amplifier 30m is a circuit for generating the reception signal Rx_TP of the capacitance method by amplifying a voltage difference between an input terminal and a ground terminal, and constitutes a circuit for receiving the touch detection signal Tx_TP in cooperation with the sensor controller 31. The input terminal of the operational amplifier 30m is connected to the wire L2 of the wiring unit 30d via the switch 30i. Accordingly, the reception signal Rx_TP is a signal present in the wire L2 and amplified. The operational amplifier 30m includes a parallel capacitor for removing high-frequency noise. The reception signal Rx_EMR generated by the operational amplifier 30e and the reception signal Rx_TP generated by the operational amplifier 30m are both supplied to the sensor controller 31.

The description will continue again with reference to FIG. 18. The sensor controller 31 according to the present embodiment has a function of detecting the position of the finger F on the touch face by using the capacitance method, as well as the function described in the first embodiment (the function of detecting the position of the electromagnetic resonance pen P within the touch face by using the EMR method, and acquiring data transmitted from the electromagnetic resonance pen P by demodulating a pen signal transmitted from the electromagnetic resonance pen P). Detection of the position of the electromagnetic resonance pen P and acquisition of data from the electromagnetic resonance pen P and detection of the position of the finger F are executed in a time-division manner. The sensor controller 31 is configured to sequentially supply the detected position and the acquired data to the host processor 32. Processing performed by the host processor 32 having received this supply is similar to the corresponding processing of the first embodiment.

A specific process performed by the sensor controller 31 for detecting the position of the electromagnetic resonance pen P and the position of the finger F will hereinafter be described with reference to FIGS. 20 through 23.

First referred to is FIG. 20 which is a diagram illustrating a state of the switch unit 30 while the sensor controller 31 of the present embodiment is detecting the position of the finger F. As illustrated in this figure, the sensor controller 31 in this case connects each of the input pins to the corresponding output pin by controlling the switch 30g. As a result, the touch detection signal Tx_TP is supplied from the sensor controller 31 to one end of each of the linear electrodes EL in the x direction. Moreover, the sensor controller 31 separates each of the input pins from the corresponding ground pin by controlling the switch 30j to bring the other end of each of the linear electrodes EL in the x direction into a floating state.

Specific details of the touch detection signal Tx_TP generated by the sensor controller 31 can be represented by a matrix A expressed as the following equation (16). The matrix A is a square matrix which has a plurality of rows corresponding to the plurality of linear electrodes EL with one-to-one correspondence. The left part of a subscript added to each of elements (e.g., A₁₁) of the matrix A indicates an output order from the sensor controller 31, while the right part of the subscript indicates a serial number of the linear electrode EL. M is a total number of the linear electrodes EL. A specific value of each of the elements is either “1” or “−1.” The matrix A is preferably an orthogonal matrix, but is not limited to an orthogonal matrix.

$$Math . 15$$

$$A = ( \begin{matrix}{A}_{11} & {A}_{21} & {A}_{31} & ⋯ & {A}_{M 1} \\ {A}_{12} & {A}_{22} & {A}_{32} & ⋯ & {A}_{M 2} \\ {A}_{13} & {A}_{23} & {A}_{33} & ⋯ & {A}_{M 3} \\ ⋮ & ⋮ & ⋮ & ⋯ & ⋮ \\ {A}_{1 M} & {A}_{2 M} & {A}_{3 M} & ⋯ & {A}_{MM}\end{matrix} ) \qquad ( 16 )$$

The sensor controller 31 generates the touch detection signal Tx_TP for each of the columns of the matrix A, and supplies the generated touch detection signal Tx_TP to each of the linear electrodes EL. The touch detection signal Tx_TP in a typical example is a binary pulse signal which has a high value for a corresponding element of “1” in the matrix A and a low value for a corresponding element of “−1” in the matrix A. The touch detection signal Tx_TP corresponding to one column of the matrix A will hereinafter be referred to as a “partial touch detection signal Tx_TP.”

The sensor controller 31 performs a process for sequentially connecting the respective loop coils LCx to the operational amplifier 30m while maintaining the connected state of the switch 30i during supply of the one partial touch detection signal Tx_TP to each of the linear electrodes EL. Specifically, the sensor controller 31 sequentially connects both ends of the respective loop coils LCx to the wire L2 by controlling the switch 30b. Note that FIG. 20 illustrates an example of a case where the loop coil LCxₙ is connected to the wire L2.

Assuming here that capacitance formed between the mth linear electrode ELₘ and the nth loop coil LCXₙ is Cₘₙ, the reception signal Rx_TP supplied from the operational amplifier 30m to the sensor controller 31 has a value expressed as the following expression (17) when the partial touch detection signal Tx_TP corresponding to the xth column of the matrix A is supplied to each of the linear electrodes EL in a state of connection between the nth loop coil LCxₙ and the operational amplifier 30m.

$$Math . 16$$

$$( \begin{matrix}{A}_{x 1} & {A}_{x 2} & {A}_{x 3} & ⋯ & {A}_{xM}\end{matrix} ) ( \begin{matrix}{C}_{1 n} \\ {C}_{2 n} \\ {C}_{3 n} \\ ⋮ \\ {C}_{Mn}\end{matrix} ) \qquad ( 17 )$$

Accordingly, the reception signal Rx_TP obtained for the nth loop coil LCxₙ during supply of the corresponding partial touch detection signal Tx_TP to each of the columns of the matrix A is indicated by a vector b expressed as the following equation (18) as a whole.

$$Math . 17$$

$$b = A ( \begin{matrix}{C}_{1 n} \\ {C}_{2 n} \\ {C}_{3 n} \\ ⋮ \\ {C}_{Mn}\end{matrix} ) \qquad ( 18 )$$

The sensor controller 31 performs calculation indicated by the left side of the following equation (19) for the foregoing vector b to separately acquire the capacitance Cₘₙ for each of the linear electrodes EL. Note that a matrix A⁻¹ indicated in equation (19) is an inverse matrix of the matrix A. As indicated in equation (19) as well, an identity matrix I is obtained by multiplying the matrix A by A⁻¹. Accordingly, by carrying out this calculation, the sensor controller 31 can separately acquire the capacitance Cₘₙ at an intersection of the nth loop coil LCxₙ and each of the linear electrodes ELₘ as indicated by the right side of equation (19).

$$Math . 18$$

$${A}^{- 1} b = {A}^{- 1} A ( \begin{matrix}{C}_{1 n} \\ {C}_{2 n} \\ {C}_{3 n} \\ ⋮ \\ {C}_{Mn}\end{matrix} ) = I ( \begin{matrix}{C}_{1 n} \\ {C}_{2 n} \\ {C}_{3 n} \\ ⋮ \\ {C}_{Mn}\end{matrix} ) = ( \begin{matrix}{C}_{1 n} \\ {C}_{2 n} \\ {C}_{3 n} \\ ⋮ \\ {C}_{Mn}\end{matrix} ) \qquad ( 19 )$$

The sensor controller 31 executes calculation similar to equation (19) for each of the loop coils LCx to derive the capacitance Cₘₙ for each of intersections of the linear electrodes EL and the loop coils LCx. Thereafter, the sensor controller 31 derives a position of the finger F in reference to distribution of the capacitance Cₘₙ thus derived for each intersection within the touch face. Specifically, a position corresponding to a peak of the distribution is derived as the position of the finger F as in detection of a position of the electromagnetic resonance pen P by the EMR method.

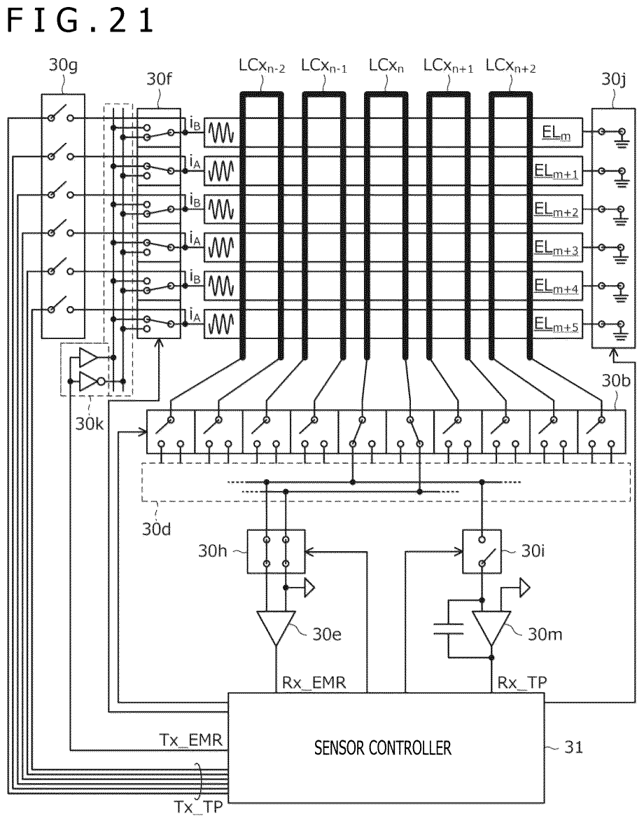

Each of FIGS. 21 through 23 referred to next is a diagram illustrating a state of the switch unit 30 while the sensor controller 31 of the present embodiment is detecting a position of the electromagnetic resonance pen P. The sensor controller 31 according to the present embodiment sequentially selects the six adjacent linear electrodes EL with a shift to the subsequent three linear electrodes EL during connection between the loop coil LCxₙ and the operational amplifier 30e by control of the switches 30b, 30h, and 30i, and connects the selected six linear electrodes EL to the driving circuit 30k in three connection modes for each selection of the linear electrodes EL in such a manner as to generate the alternating current i_{A} in half of the six linear electrodes EL and the alternating current i_{B} in the remaining half of the six linear electrodes EL by controlling the switch 30f. Moreover, the sensor controller 31 brings the other end of each of the linear electrodes EL in the x direction into a grounded state by controlling the switch 30j such that each of the input pins is connected to the corresponding ground pin.

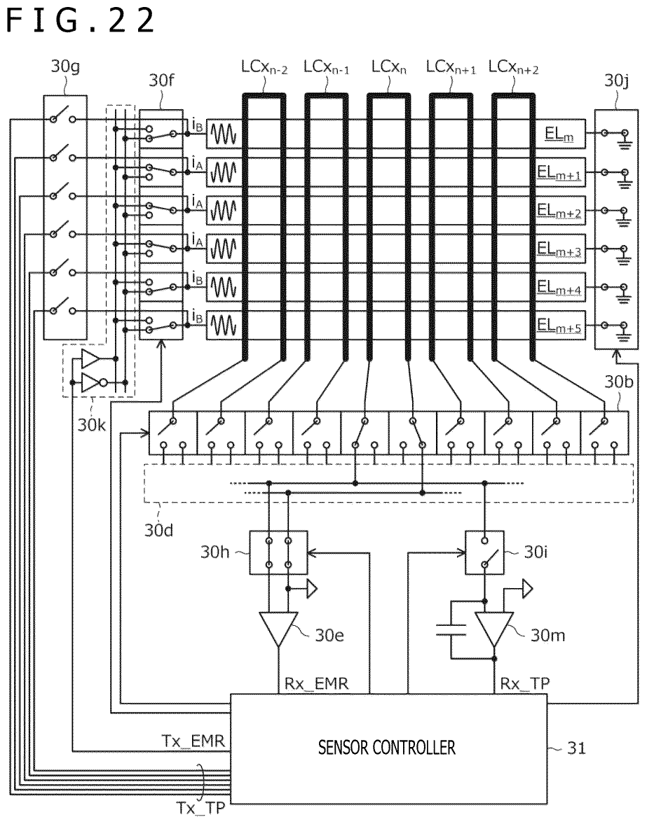

FIGS. 21 through 23 illustrate supply of the alternating current i_{A} and the alternating current i_{B} in the three connection modes described above. Specifically, in the example of FIG. 21, the alternating current i_{A} is supplied to the linear electrodes ELₘ₊₁, ELₘ₊₃, and ELₘ₊₅, while the alternating current i_{B} is supplied to the linear electrodes ELₘ, ELₘ₊₂, and ELₘ₊₄. Meanwhile, in the example of FIG. 22, the alternating current i_{A} is supplied to the linear electrodes ELₘ₊₁ through ELₘ₊₃, while the alternating current i_{B} is supplied to the linear electrodes ELₘ, ELₘ₊₄, and ELₘ₊₅. In the example of FIG. 23, the alternating current i_{A} is supplied to the linear electrodes ELₘ₊₂ through ELₘ₊₄, while the alternating current in is supplied to the linear electrodes ELₘ, ELₘ₊₁, and ELₘ₊₅.

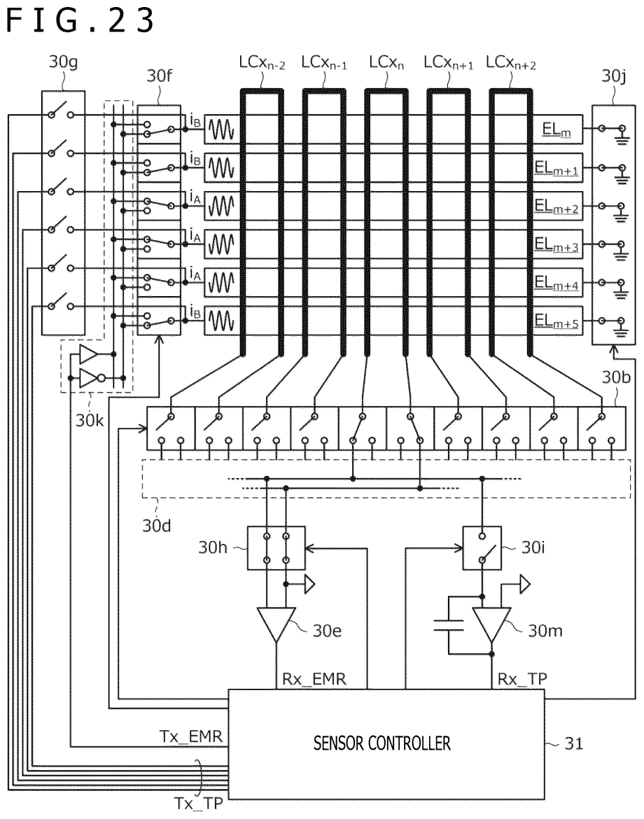

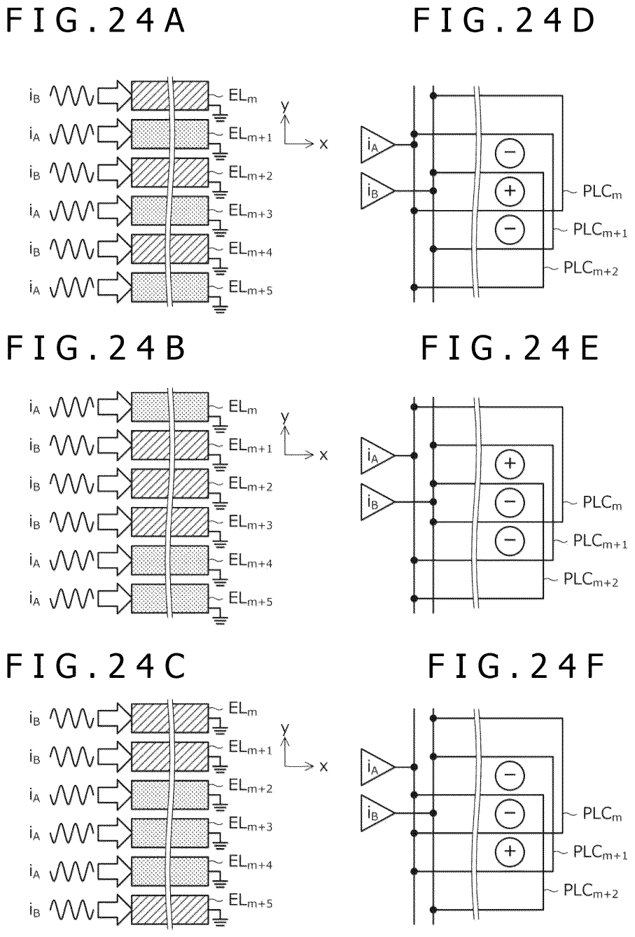

FIGS. 24A through 24C are diagrams schematically illustrating the methods for supplying the alternating current illustrated in FIGS. 21 through 23, respectively. Meanwhile, FIGS. 24D through 24F are diagrams illustrating equivalent circuits provided when the alternating current i_{A} and the alternating current in are supplied to the six linear electrodes ELₘ through ELₘ₊₅ by the methods illustrated in FIGS. 24A through 24C, respectively. As can be seen from these figures, when the alternating current supplied to the linear electrode ELₘ₊ₖ (k: any one of 0, 1, 2) and the alternating current supplied to the linear electrode ELₘ₊ₖ₊₃ have opposite time derivatives, a loop coil is considered to be formed by the linear electrode ELₘ₊ₖ and the linear electrode ELₘ₊ₖ₊₃ regardless of the current flowing in the linear electrodes ELₘ₊ₖ₊₁ and ELₘ₊ₖ₊₂ located between the linear electrodes ELₘ₊ₖ and ELₘ₊ₖ₊₃. Hereinafter, this loop coil will be referred to as a “pseudo loop coil PLC” (sending coil conductor); particularly the pseudo loop coil constituted by the linear electrodes ELₘ₊ₖ and ELₘ₊ₖ₊₃ will be referred to as a “pseudo loop coil PLCₘ₊ₖ.” The connection polarity of the pseudo loop coil PLCₘ₊ₖ at the time of supply of the alternating current i_{A} to the linear electrode ELₘ₊ₖ and supply of the alternating current is to the linear electrode ELₘ₊ₖ₊₃ (expressed as “−” in the figure) is opposite to the connection polarity of the pseudo loop coil PLCₘ₊ₖ at the time of supply of the alternating current is to the linear electrode ELₘ₊ₖ and supply of the alternating current i_{A} to the linear electrode ELₘ₊ₖ₊₃ (expressed as “+” in the figure).

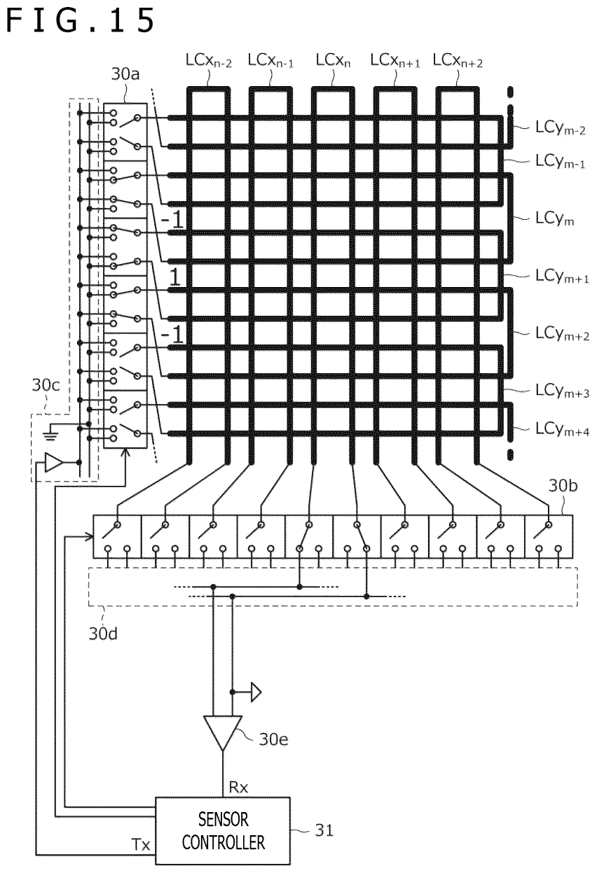

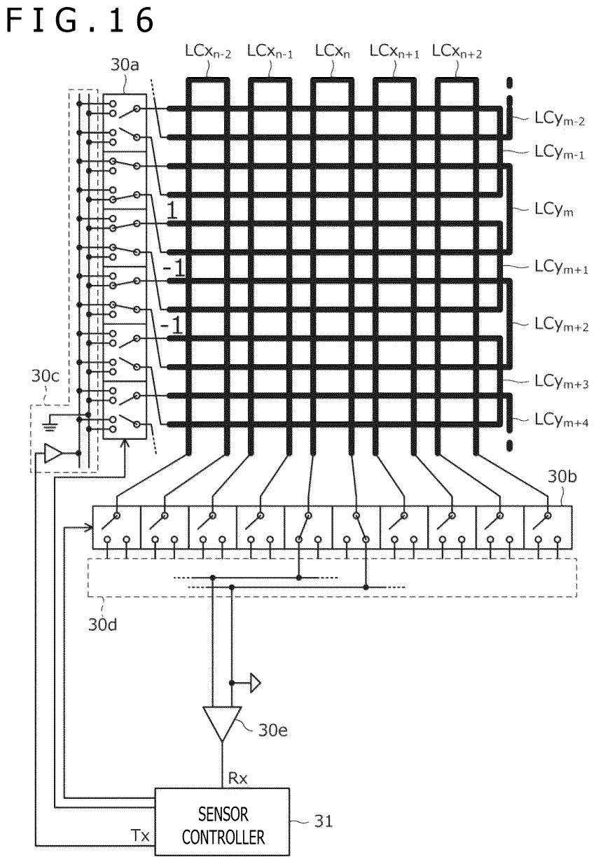

The positions and the connection polarities of the respective pseudo loop coils PLC illustrated in FIG. 24D are completely the same as the positions and the connection polarities of the respective loop coils LCy illustrated in FIG. 15. Similarly, the positions and the connection polarities of the respective pseudo loop coils PLC illustrated in FIG. 24E are completely the same as the positions and the connection polarities of the respective loop coils LCy illustrated in FIG. 16, and the positions and the connection polarities of the respective pseudo loop coils PLC illustrated in FIG. 24F are completely the same as the positions and the connection polarities of the respective loop coils LCy illustrated in FIG. 17. Accordingly, the position detection system 1 according to the present embodiment can detect the position of the electromagnetic resonance pen P in a manner similar to the manner of the position detection system 1 of the second embodiment.

More specifically, assuming that a level of a pen signal received by the loop coil LCxₙ at the time of supply of the alternating current i_{A} to the linear electrode ELₘ₊ₖ and supply of the alternating current is to the linear electrode ELₘ₊ₖ₊₃ is expressed as E_{m+k,n}, the reception signal Rx_EMR (result value) supplied from the operational amplifier 30e to the sensor controller 31 during supply of the alternating current as illustrated in FIG. 24A is expressed as −Em,n+Em+1,n−Em+2,n. This applies to supply of the alternating current as illustrated in FIGS. 24B and 24C. The respective reception signals Rx_EMR are expressed as Em, n−Em+1,n−Em+2,n and −Em,n−Em+1,n+Em+2,n. These results are expressed as a vector d_{EL} in the following equation (20) in the form of a vector. This vector has completely the same form as the form of the vector d_{LC} expressed in equation (1) described above. In addition, similarly to the vector d_{LC}, the vector d_{EL} can be deformed into a form of a product of a 3×3 matrix F indicating the connection polarity of the pseudo loop coil PLC and vectors indicating the levels E_{m,n} to Em+2,n.

$$Math . 19$$

$$\begin{matrix}{d}_{EL} = ( \begin{matrix}- {E}_{m , n} + {E}_{m + 1 , n} - {E}_{m + 2 , n} \\ + {E}_{m , n} - {E}_{m + 1 , n} - {E}_{m + 2 , n} \\ - {E}_{m , n} - {E}_{m + 1 , n} + {E}_{m + 2 , n}\end{matrix} ) \\ = ( \begin{matrix}- 1 & 1 & - 1 \\ 1 & - 1 & - 1 \\ - 1 & - 1 & 1\end{matrix} ) ( \begin{matrix}{E}_{m , n} \\ {E}_{m + 1 , n} \\ {E}_{m + 2 , n}\end{matrix} ) = F ( \begin{matrix}{E}_{m , n} \\ {E}_{m + 1 , n} \\ {E}_{m + 2 , n}\end{matrix} )\end{matrix} \qquad ( 20 )$$

As can be understood from the fact that the vector d_{EL} has the same form as that of the vector d_{LC}, the sensor controller 31 according to the present embodiment can also separately acquire the levels E_{m,n}, Em+1,n, and Em+2,n of the pen signal received at the time of sending of alternating magnetic fields from the pseudo loop coils PLCₘ to PLCₘ₊₂, respectively, by multiplying the vector d_{EL} by the inverse matrix F⁻¹ of the matrix F. In addition, according to the alternating current supply method of the present embodiment, the period for sending the alternating magnetic fields from the respective pseudo loop coils PLC is three times longer than that period for independently sending the alternating magnetic field from each of the three pseudo coils PLC. In this case, the received pen signal has a three times higher level, but the received noise has only a 3½ times higher level. Accordingly, the alternating current supply method of the present embodiment is also considered to improve the signal to noise ratio of pen signals received by the sensor controller 31.

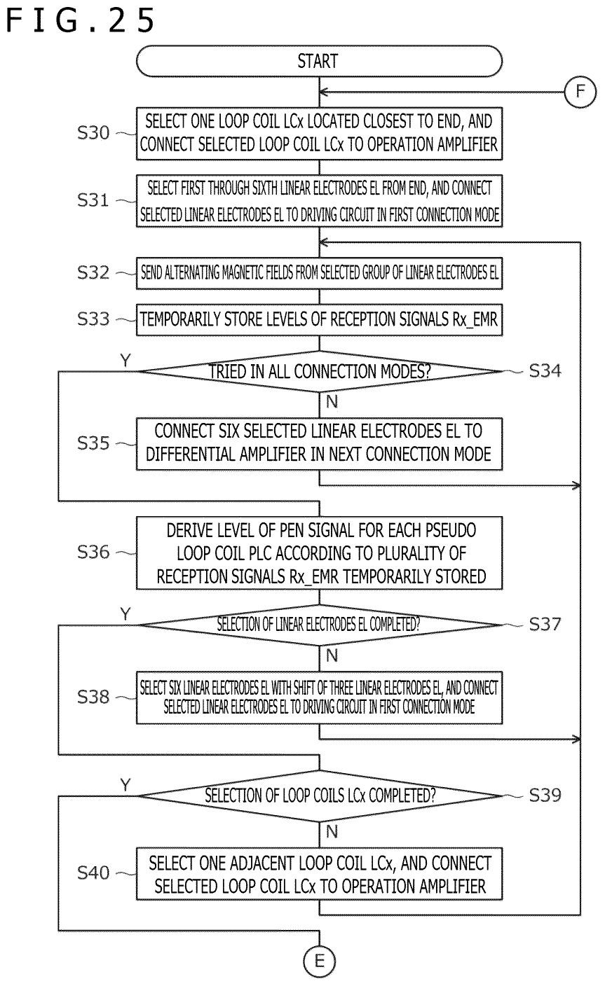

Each of FIGS. 25 through 27 is a flowchart illustrating an overall flow executed by the sensor controller 31 according to the present embodiment to detect a position of the electromagnetic resonance pen P. Described with reference to FIG. 25 first, before detection of the electromagnetic resonance pen P, the sensor controller 31 first selects the loop coil LCx located closest to the end, and connects the selected loop coil LCx to the operational amplifier 30e by controlling the switch 30b (step S30). This processing also includes processing for connecting the operational amplifier 30e to the wire L2 and grounding the wire L1 by controlling the switch 30h, and processing for separating the operational amplifier 30m from the wire L2 by controlling the switch 30i.

Next, the sensor controller 31 selects the first to sixth linear electrodes EL from the end, and connects the selected linear electrodes EL to the driving circuit 30k in the first connection mode (e.g., the connection mode illustrated in FIG. 23) by controlling the switch 30f (step S31). This processing also includes processing for grounding the other ends of the respective linear electrodes EL in the x direction by controlling the switch 30j and processing for preventing supply of the touch detection signal Tx_TP to the respective electrodes EL by controlling the switch 30g.

Subsequently, the sensor controller 31 starts sending of alternating magnetic fields from the selected linear electrode EL group (step S32). Specifically, the sensor controller 31 starts supply of alternating current Tx_EMR to the driving circuit 30k. With the start of this supply, either the alternating current i_{A} or the alternating current in is generated in each of the six linear electrodes EL. As a result, the pseudo loop coils PLC described above are formed, and alternating magnetic fields are sent therefrom. Thereafter, the sensor controller 31 temporarily stores levels of the reception signal Rx_EMR output from the operational amplifier 30e according to the alternating magnetic fields sent in step S32 (step S33).

Subsequently, the sensor controller 31 determines whether or not the processing in steps S32 and S33 has been tried in all of the connection modes (step S34). Specifically, the sensor controller 31 determines whether or not the processing in steps S32 and S33 has been tried in all of the three connection modes illustrated in FIGS. 21 through 23. The sensor controller 31 determining that the trial has not yet been completed connects the selected six linear electrodes EL to the driving circuit 30k in the subsequent connection mode (e.g., the connection mode subsequent to the connection mode illustrated in FIG. 21 is the connection mode illustrated in FIG. 22, and the connection mode subsequent to the connection mode illustrated in FIG. 22 is the connection mode illustrated in FIG. 23) by controlling the switch 30f (step S35), and then returns to step S32.

On the other hand, the sensor controller 31 determining that the trial has been completed in step S34 derives a level of the pen signal for each of the pseudo loop coils PLC according to a plurality of levels of the reception signal Rx_EMR temporarily stored by a plurality of times of the trial in step S33 (step S36). Specifically, the calculation for multiplying the vector d_{EL} described above by the inverse matrix F⁻¹ of the matrix F (restoring calculation) is carried out.

Subsequently, the sensor controller 31 determines whether or not selection of all of the linear electrodes EL has been completed (step S37). If determining that this selection has not been completed yet, the sensor controller 31 selects the six linear electrodes EL with a shift to the subsequent three linear electrodes EL, and connects the selected six linear electrodes EL to the driving circuit 30k in the first connection mode (e.g., the connection mode illustrated in FIG. 21) by controlling the switch 30f (step S38). Thereafter, the flow returns to step S32. On the other hand, if determining that the selection has been completed in step S37, the sensor controller 31 determines whether or not selection of all of the loop coils LCx has been completed (step S39). If determining that this selection has not been completed yet, the sensor controller 31 selects the one loop coil LCx adjacent to the one loop coil LCx previously selected (selected in step S30 or S40), and connects the selected loop coil LCx to the operational amplifier 30e by controlling the switch 30b (step S40). Thereafter, the flow returns to step S32.

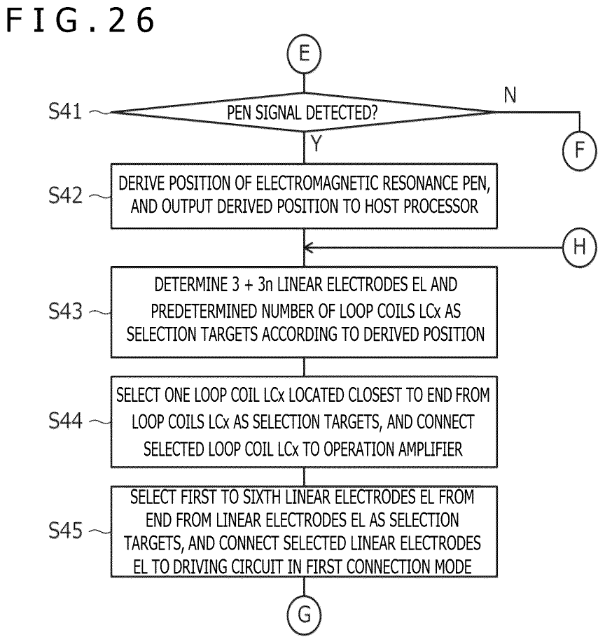

The sensor controller 31 determining in step S39 that the selection has been completed determines whether or not a pen signal has been detected, according to the levels of the pen signal obtained by repeating step S36 for each combination of the pseudo loop coils PLC and the loop coil LCx (step S41 in FIG. 26). In one example, the result of this determination is positive for a level exceeding a predetermined value, and is negative for other cases.

The sensor controller 31 determining that no pen signal is detected in step S41 returns to step S30 in FIG. 25, and continues processing. On the other hand, the sensor controller 31 determining that a pen signal has been detected derives a position of the electromagnetic resonance pen P, according to the levels of the pen signal derived in step S36 in FIG. 25 for each combination of the pseudo loop coils PLC and the loop coil LCx, and outputs the derived position to the host processor 32 (step S42).

Next, the sensor controller 31 determines the 3+3n (n: natural number, typically n=1; note that 3+3n is a number smaller than the total number of the linear electrodes EL) linear electrodes EL (linear electrode set) and a predetermined number (a number smaller than the total number of the loop coils LCx, typically 3 or 4) of loop coils LCx as selection targets according to the position derived in step S42 (a position derived in previous step S56 in a case of transition from step S56 described later) (step S43).

Subsequently, the sensor controller 31 connects the loop coil LCx located closest to the end from the loop coils LCx corresponding to the selection targets, and connects the selected loop coil LCx to the operational amplifier 30e by controlling the switch 30b (step S44). Moreover, the sensor controller 31 selects the first through sixth linear electrodes EL from the end from the linear electrodes EL corresponding to the selection targets, and connects the selected six linear electrodes EL to the driving circuit 30k in the first connection mode (e.g., the connection mode illustrated in FIG. 21) by controlling the switch 30f (step S45).

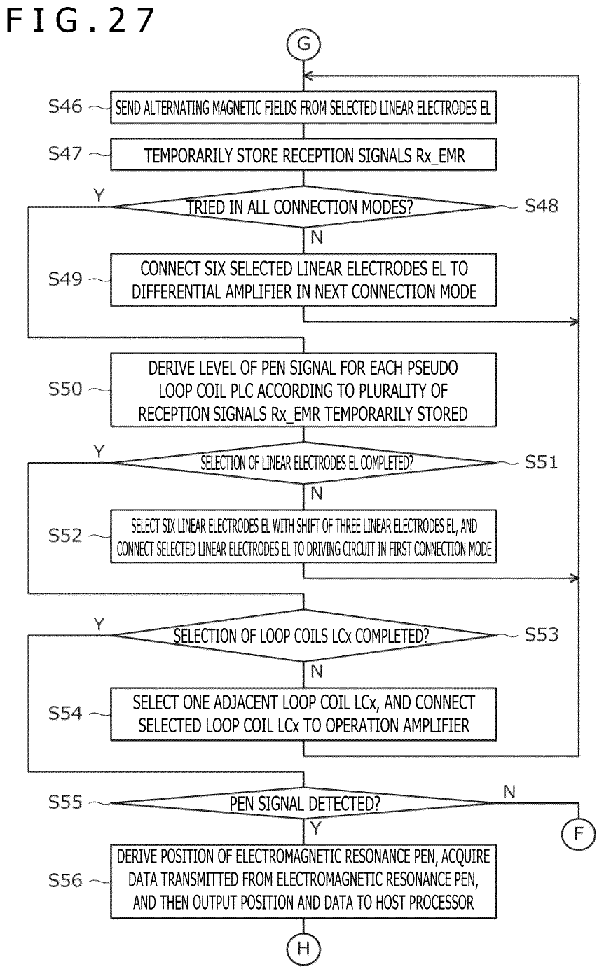

Described with reference to FIG. 27, the sensor controller 31 then performs processing similar to the processing in steps S32 through S41 in FIGS. 25 and 26 (steps S46 through S55). Note that the processing here is different from the processing in steps S32 through S41 in that step S47 also stores a series of digital values (obtained by sampling) constituting the reception signal Rx_EMR unlike step S33 which temporarily stores only the levels of the reception signal Rx_EMR, that step S51 determines whether or not selection of all of the linear electrodes EL determined as the selection targets in step S43 has been completed unlike step S37 which determines whether or not selection of all of the linear electrodes EL has been completed, and that step S53 determines whether or not selection of all of the loop coils LCx determined as the selection targets in step S43 has been completed unlike step S39 which determines whether or not selection of all of the loop coils LCx has been completed.

The sensor controller 31 determining that the pen signal has been detected in step S55 derives a position of the electromagnetic resonance pen P, acquires data transmitted from the electromagnetic resonance pen P, and then outputs those to the host processor 32 (step S56). Specifically, the sensor controller 31 derives the position of the electromagnetic resonance pen P, according to the levels of the pen signal for each combination of the pseudo loop coils PLC and the loop coil LCx derived in step S50. Moreover, the sensor controller 31 demodulates the series of digital values stored in step S47 for the combination of the pseudo loop coils PLC and the loop coil LCx located closest to the derived position, to acquire the data transmitted by the electromagnetic resonance pen P. After completion of step S56, the sensor controller 31 returns to step S43 and continues processing.

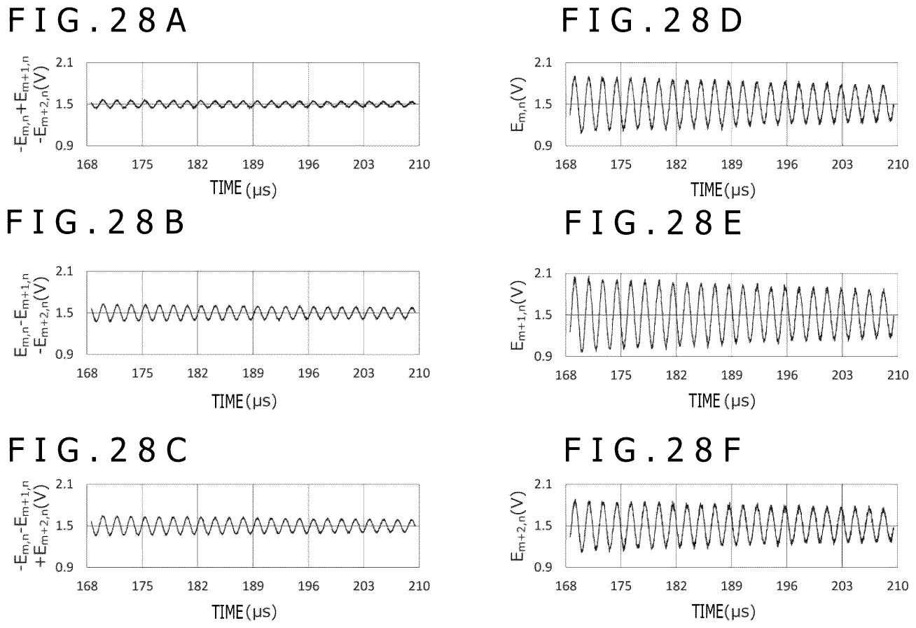

The position detection method of the present embodiment can also improve the signal to noise ratio of pen signals received by the sensor controller 31, without lowering frequency of position detection and without increasing the circuit scale of the sensor controller 31. These advantageous effects will hereinafter be described in detail with reference to experimental results. FIGS. 28A through 28C are diagrams illustrating the reception signal Rx_EMR (−E_{m,n}+E_{m+1,n}−E_{m+2,n}, E_{m,n}−E_{m+1,n}−E_{m+2,n}, −E_{m,n}−E_{m+1,n}+E_{m+2,n}) input to the sensor controller 31 when the electromagnetic resonance pen P is located above the pseudo loop coil PLCₘ₊₁ in the connection modes of FIGS. 24A through 24C, respectively. FIGS. 28D through 28F are diagrams illustrating levels E_{m,n}, Eₘ₊₁₊ₙ, and E_{m+2,n} of the pen signal obtained by the restoring calculation expressed as equation (20) when the reception signal Rx_EMR illustrated in FIGS. 28A through 28C is acquired, respectively.

As can be understood by comparison between FIGS. 28A through 28C and FIGS. 28D through 28E, the levels of the pen signal available after restoring calculation are considerably higher than the levels of the reception signal Rx_MER. This increase is produced because the pen signal detection period of the position detection method according to the present embodiment is three times longer than an ordinary pen signal detection period as explained in the first embodiment. When the pen signal detection period for the pen signal of the sensor controller 31 becomes N times longer here, the received pen signal has an N-times higher level. Meanwhile, received noise has only an N^{1/2} higher level as described above. Accordingly, the position detection system 1 of the present embodiment is also considered to improve the signal to noise ratio of pen signals received by the sensor controller 31, without lowering frequency of position detection and without increasing the circuit scale of the sensor controller 31.

This advantageous effects can similarly be offered even when the electromagnetic resonance pen P is tilted. This point will hereinafter be described.

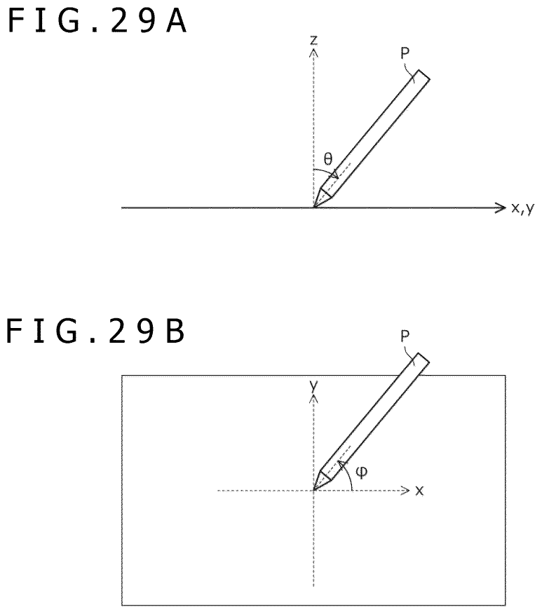

First referred to are FIGS. 29A and 29B which are diagrams illustrating angles θ and σ each indicating a tilt of the electromagnetic resonance pen P. FIG. 29A illustrates the angle θ. As illustrated in this figure, the angle θ is an angle formed by a z direction perpendicular to the touch face and a pen axis. The angle θ is also called a “tilt angle.” FIG. 29B illustrates the angle φ. As illustrated in this figure, the angle φ is an angle formed by the x direction corresponding to an extension direction of the loop coils LCy and the pen axis.

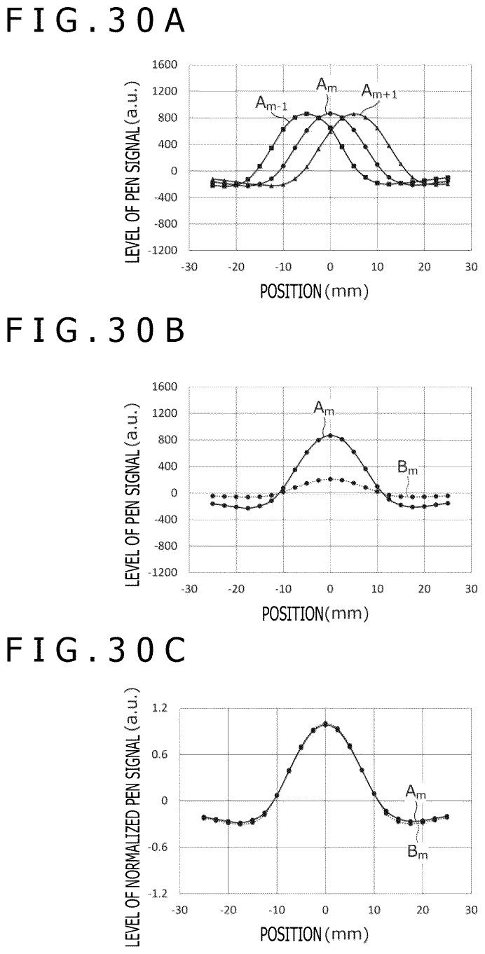

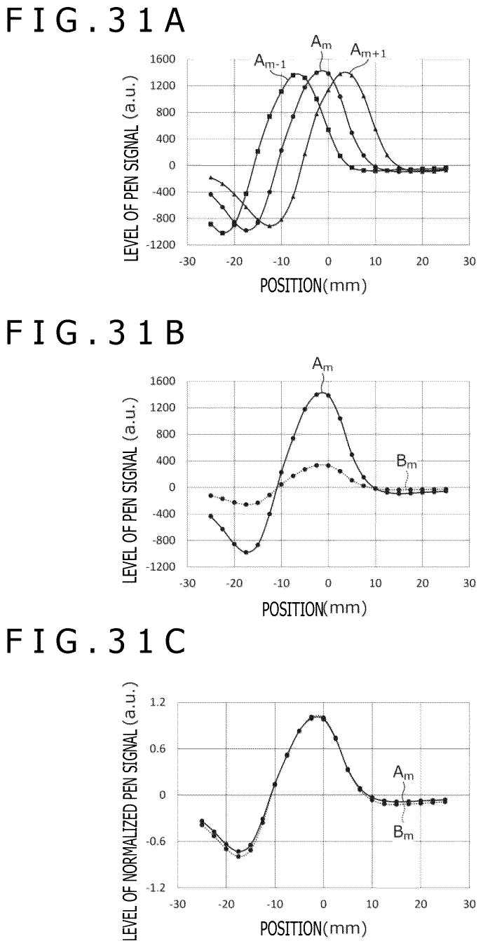

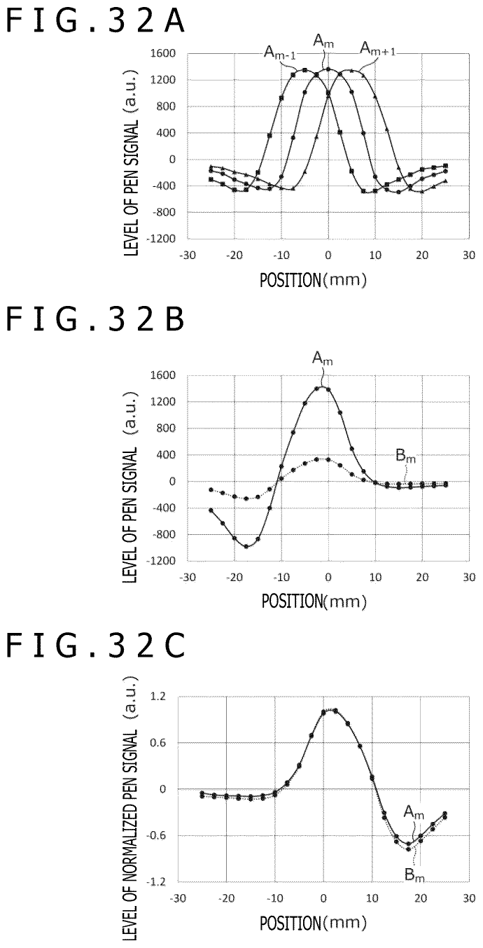

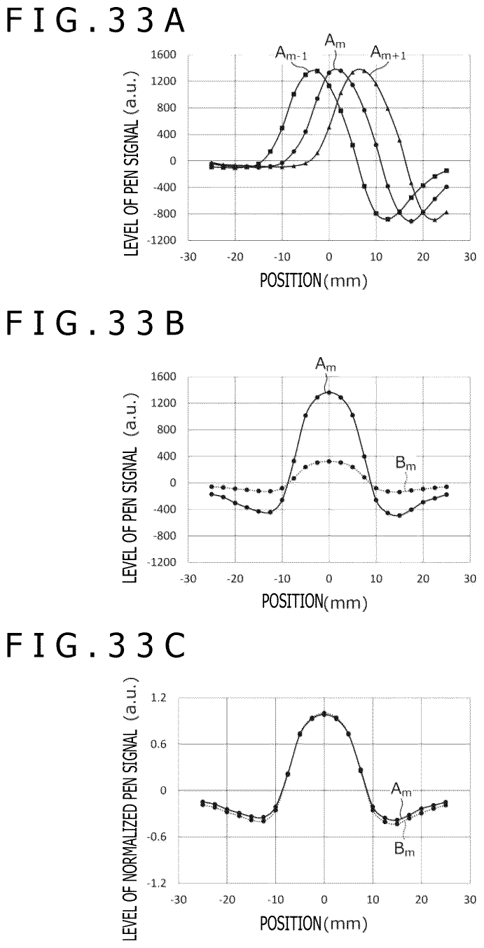

FIGS. 30A through 33C are diagrams illustrating levels of a pen signal obtained when (θ, φ)=(0, 0), (60, 0), (60, 90), and (60, 180), respectively. The horizontal axis in each of the figures represents a position in the y direction in millimeters. In each of the figures, −5 mm, 0 mm, and +5 mm of the horizontal axis correspond to positions of the pseudo loop coils PLCₘ₋₁, PLCₘ, and PLCₘ₊₁, respectively. Meanwhile, the vertical axis in each of FIGS. 30A through 31C represents levels of pen signals (levels after restoring calculation when restoring calculation is carried out) in any unit (a. u.), while the vertical axis in FIGS. 32A through 32C represents values obtained by normalizing levels of pen signals on an assumption that the maximum value is 1.

Graphs Aₘ₋₁, Aₘ, and Aₘ₋₁ represent levels of pen signals at respective positions obtained by the sensor controller 31 according to the present embodiment when the electromagnetic resonance pen P in the y direction is located at −5, 0, and +5. Meanwhile, a graph Bm represents levels of pen signals at respective positions acquired by the sensor controller 31 when an alternating magnetic field is sent from only the one pseudo loop coil PLCₘ (i.e., when alternating current is supplied to only the linear electrodes ELₘ and ELₘ₊₃) in a comparative example for the present embodiment.

First, as can be understood with reference to FIGS. 30A, 31A, 32A, and 33A, a value equivalent to or higher than a value of (θ, φ)=(0, 0) is obtained as the maximum value of levels of pen signals acquired by the sensor controller 31 according to the present embodiment even when the angles θ and φ are not 0. The maximum value of the level of the pen signal in the case of the angle θ=60° exceeds the maximum value of that level in the case of the angle θ=0° because distances between the coils within the electromagnetic resonance pen P and the touch face decrease with an increase in the angle θ. Moreover, as can be understood with reference to FIGS. 30B, 31B, 32B, and 33B, a value equivalent to or higher than a value of (θ, φ)=(0, 0) is obtained as a ratio of levels of pen signals acquired by the sensor controller 31 according to the present embodiment to levels of pen signals acquired by the sensor controller 31 in the comparative example even when the angles θ and φ are not 0. Accordingly, the position detection method of the present embodiment is considered to improve the signal to noise ratio of pen signals received by the sensor controller 31 regardless of the values of the angles θ and φ.

Subsequently, as can be understood with reference to FIGS. 30C, 31C, 32C, and 33C, distribution of levels of pen signals acquired by the sensor controller 31 according to the present embodiment has a shape substantially identical to a shape of distribution of levels of pen signals acquired by the sensor controller 31 in the comparative example. Accordingly, when the position detection method according to the present embodiment is adopted, no error is considered to be produced in the results of position detection.

As obvious from above, the position detection method according to the present embodiment is also considered to improve the signal to noise ratio of pen signals received by the sensor controller 31, without lowering frequency of position detection and without increasing the circuit scale of the sensor controller 31, as in the above case, even when the electromagnetic resonance pen P is tilted.

The position detection system 1 according to a fourth embodiment of the present disclosure will be described next. The position detection system 1 of the present embodiment is different from the position detection system 1 of the third embodiment in the manner for selecting the linear electrodes EL in which alternating current is to be simultaneously generated. Other points of the position detection system 1 of the present embodiment are similar to the corresponding points of the position detection system 1 of the third embodiment. Accordingly, the description will continue while focus is placed on the different points from the position detection system of the third embodiment.

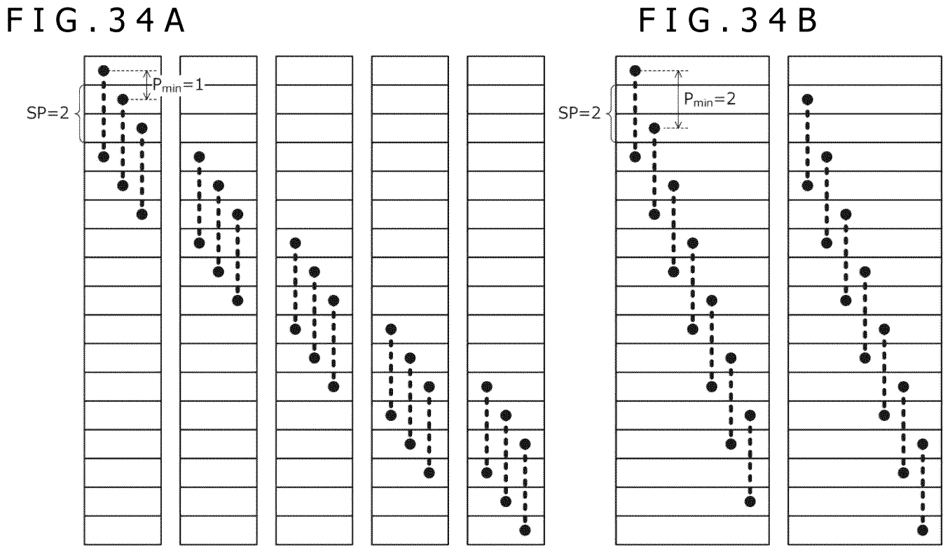

FIG. 34A is a diagram illustrating a method performed by the position detection system 1 according to the third embodiment to select the linear electrodes EL, while FIG. 34B is a diagram illustrating a method performed by the position detection system 1 according to the present embodiment to select the linear electrodes EL. In each of these figures, one rectangle represents one linear electrode EL, and each pair of the linear electrodes EL connected by a thick broken line having black circles at both ends corresponds to one pseudo coil PLC. Assuming that a space between two linear electrodes EL constituting one pseudo loop coil PLC is referred to as a sensor space SP, SP is 2 in each of the third embodiment and the present embodiment. Moreover, assuming that an interval between the adjacent pseudo loop coils PLC is referred to as a minimum pitch Pₘᵢₙ, Pₘᵢₙ is 1 in the third embodiment, while Pₘᵢₙ is 2 in the present embodiment. While the linear electrode EL not constituting the pseudo loop coil PLC is not disposed between the linear electrodes EL constituting the pseudo loop coil PLC in the case of Pₘᵢₙ=1 as illustrated in FIG. 34A, the linear electrode EL not constituting the pseudo loop coil PLC (e.g., the second linear electrode EL from the top and the third linear electrode EL from the bottom in the left diagram of FIG. 34B) is disposed between a plurality of linear electrodes EL constituting the pseudo loop coil PLC in the case of Pₘᵢₙ=2 as illustrated in FIG. 34B.

When Pₘᵢₙ=1 (minimum value) is adopted as in the third embodiment, three pseudo loop coils PLC can be simultaneously formed at most. The fourth pseudo loop coil PLC is difficult to form because the same linear electrode EL needs to be shared by two of the pseudo loop coils PLC. In contrast, when Pₘᵢₙ=2 (minimum value+1) is adopted as in the fourth embodiment, an unlimited number of the pseudo loop coils PLC can be simultaneously formed. When an unlimited number of the pseudo loop coils PLC can be simultaneously formed as in this configuration, levels of pen signals acquired by restoring calculation can be raised. This point will hereinafter be described.

It is first assumed in the following description that a method for simultaneously forming the n pseudo loop coils PLC to detect the reception signals Rx_EMR will be referred to as “CDMn.” “CDM” is an abbreviation of “Code Division Multiplexing,” while n is a degree of CDM. For using CDMn, alternating magnetic fields are sent in n types of polarity patterns from the n pseudo loop coils PLC, and n types of reception results thus obtained are multiplied by an n×n matrix. In this manner, a level can be restored for each of the pseudo loop coils PLC as in the third embodiment.

FIG. 34A illustrates an example of “CDM3,” while FIG. 34B illustrates an example of “CDM7.” As described above, three pseudo loop coils PLC can be simultaneously formed at most in the case of Pₘᵢₙ=1. Accordingly, FIG. 34A illustrates a case where the degree n is set to the maximum value allowed in this state. Meanwhile, an unlimited number of pseudo loop coils PLC can be simultaneously formed in the case of Pₘᵢₙ=2. Accordingly, a higher degree n than 7 indicated in FIG. 34B is adoptable depending on the total number of the linear electrodes EL.

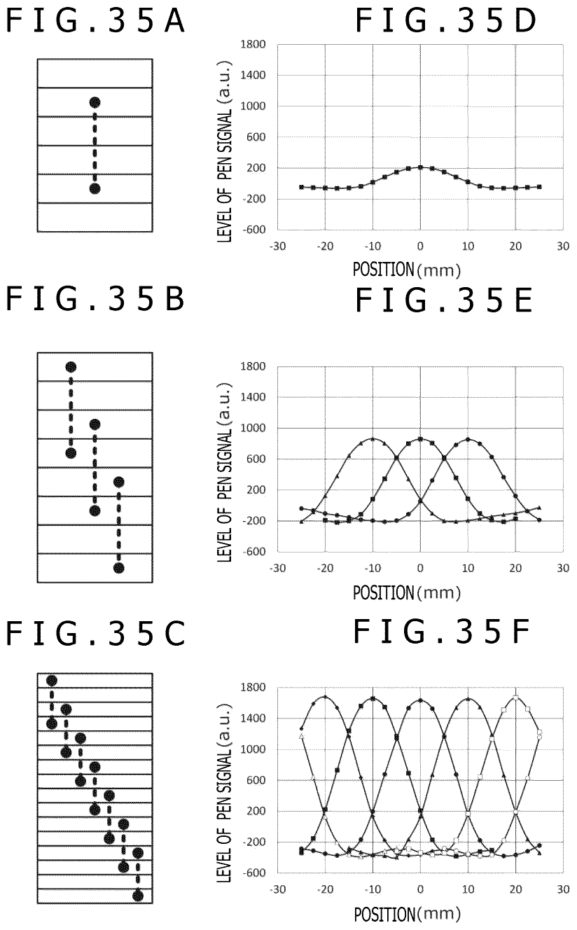

FIGS. 35A, 35B, and 35C are diagrams illustrating methods for selecting the linear electrodes EL for CDM1, CDM3, and CDM7, respectively, while FIGS. 35D, 35E, and 35F are diagrams illustrating levels of a pen signal (levels after restoring calculation when restoring calculation is carried out) obtained by CDM1, CDM3, and CDM7, respectively. In these figures, the linear electrodes EL are arranged with a pitch of 5 mm. Each of FIGS. 35E and 35F illustrates levels of a pen signal for the respective linear electrodes EL when the electromagnetic resonance pen P is located at the center of each of the pseudo loop coils PLC.

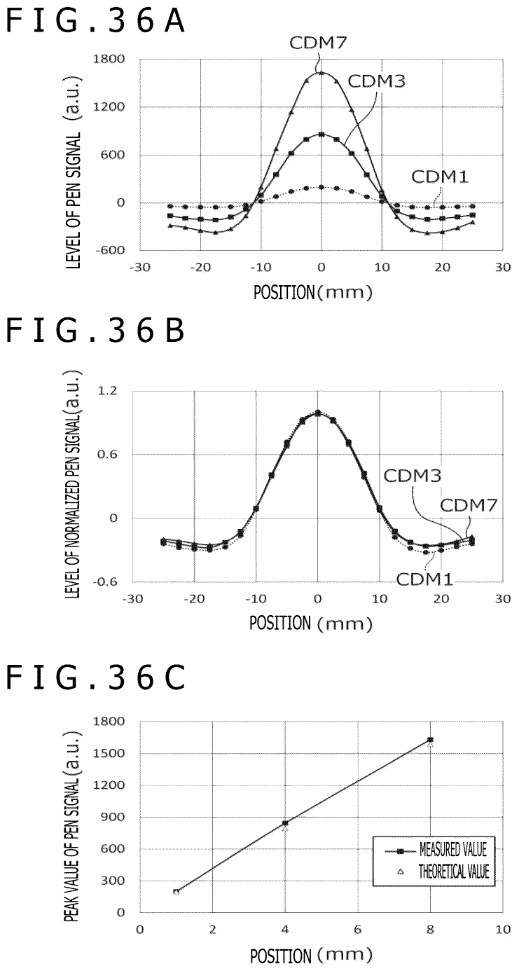

Moreover, each of FIGS. 36A and 36B is a diagram illustrating levels of a pen signal acquired when CDM1, CDM3, and CDM7 are used. The vertical axis in FIG. 36A represents levels of a pen signal (levels after restoring calculation when restoring calculation is carried out) in any unit (a. u.), while the vertical axis in FIG. 36B represents values obtained by normalizing levels of a pen signal in any unit on an assumption that the maximum value is 1. In addition, FIG. 36C is a diagram formed by plotting measured values and theoretical values for peak values of levels of a pen signal for each of CDM1, CDM3, and CDM7.

As can be understood from comparison between FIGS. 35D, 35E, and 35F, and the results in FIGS. 36A and 36C, the levels of the acquired pen signal increase as the degree n of CDM becomes higher. Meanwhile, as illustrated in FIG. 36B, the distribution of the levels of the pen signal forms substantially the same shape for each of CDM1, CDM3, and CDM7. Accordingly, it is considered that a level of detection of the position of the electromagnetic resonance pen P equivalent to the level of that detection of the third embodiment and also an increase in levels of pen signals acquired by restoring calculation are both considered to be achievable by adopting Pₘᵢₙ=2 (minimum value+1), and performing CDM at a degree higher than 3 as in the present embodiment.

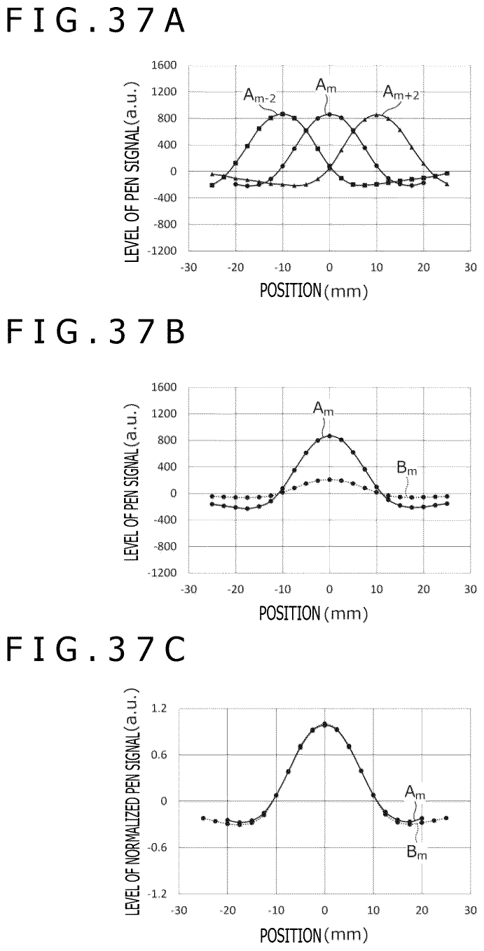

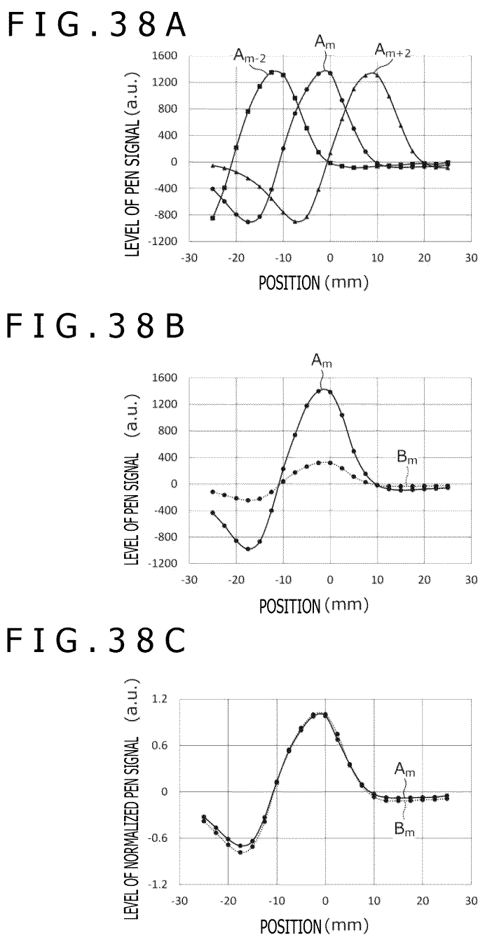

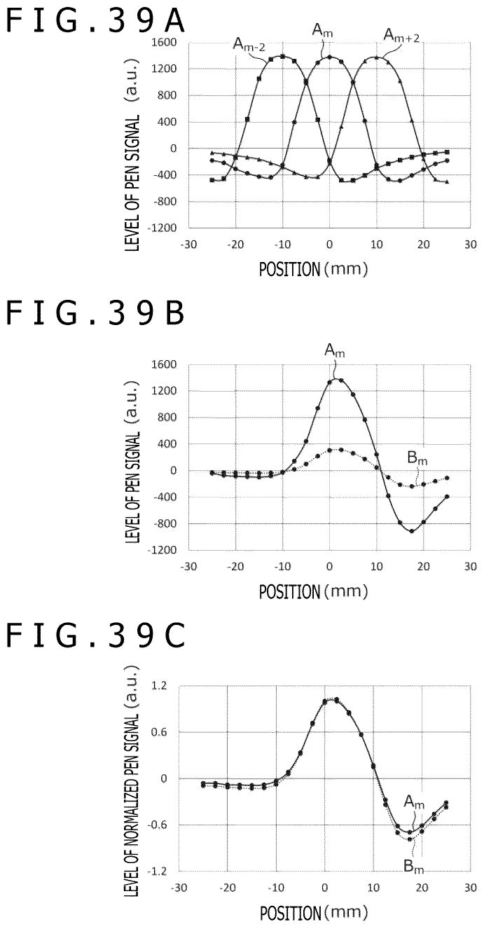

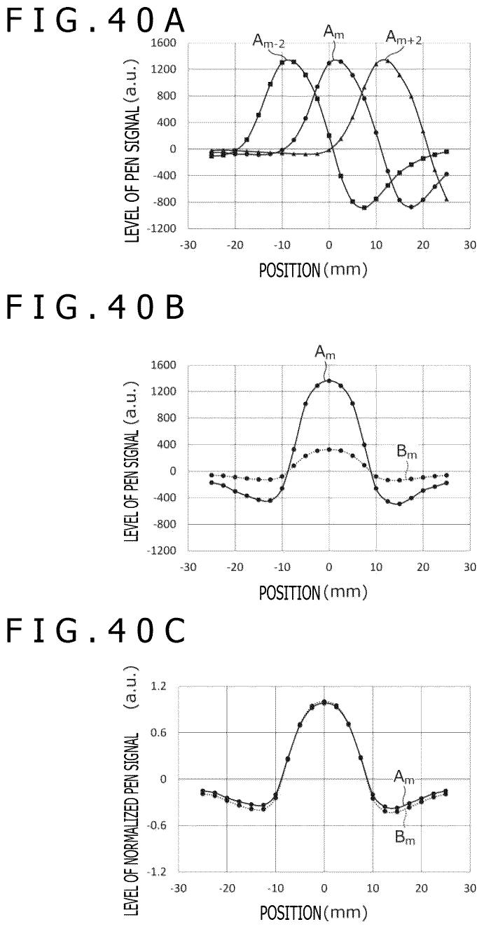

FIGS. 37A through 40C are diagrams illustrating levels of a pen signal obtained under (θ, φ)=(0, 0), (60, 0), (60, 90), and (60, 180), respectively, when the pen signal is received by CDM3 in the case of Pₘᵢₙ=2, in a manner similar to the manner of FIGS. 30A through 33C. As can be understood from comparison between FIGS. 37A through 40C and FIGS. 30A through 33C, distribution and values of levels of the received pen signal are substantially the same for the cases of Pₘᵢₙ=2 and Pₘᵢₙ=1. Accordingly, the position detection system 1 according to the present embodiment is considered to achieve detection of the position of the electromagnetic resonance pen P similarly to the position detection system 1 of the third embodiment even when the angles θ and σ are taken into consideration.

While the preferred embodiments of the present disclosure have been described above, it should be taken as a matter of course that the present disclosure is not limited to the presented embodiments in any way, and can be practiced in various modes without departing from the scope of the subject matters of the disclosure.

For example, described in the third and fourth embodiments has been the example which grounds the other end of each of the linear electrodes EL in the x direction, and supplies the current i_{A} to one end of one of the two linear electrodes EL constituting the pseudo loop coil PLC and the current is to one end of the other linear electrode EL to send alternating magnetic fields from the pseudo loop coils PLC at the time of detection of the position of the electromagnetic resonance pen P. However, alternating magnetic fields may be sent from the pseudo loop coils PLC by use of other methods.

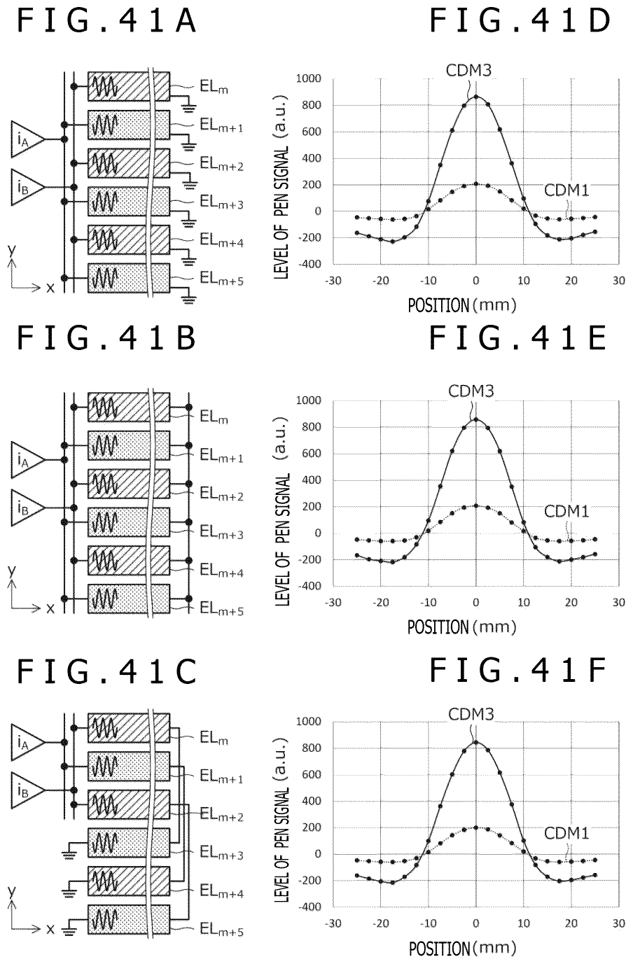

FIGS. 41A, 41B, and 41C are diagrams illustrating cases for sending alternating magnetic fields from the pseudo loop coils PLC by different methods. In addition, FIGS. 41D, 41E, and 41F are diagrams illustrating levels of a pen signal obtained when the alternating magnetic fields are sent from the pseudo loop coils PLC by the methods illustrated in FIGS. 41A, 41B and 41C, respectively.

FIG. 41A illustrates the case using the method which grounds the other end of each of the linear electrodes EL in the x direction, and supplies the current i_{A} to one end of one of the two linear electrodes EL constituting the pseudo loop coil PLC and the current is to one end of the other linear electrode EL, at the time of detection of the position of the electromagnetic resonance pen P, as in the third and fourth embodiment described above. Meanwhile, FIG. 41B illustrates the case using the method which connects the other ends of the respective linear electrodes EL in the x direction to each other, and supplies the current i_{A} to one end of one of the two linear electrodes EL constituting the pseudo loop coil PLC and the current is to one end of the other linear electrode EL, at the time of detection of the position of the electromagnetic resonance pen P. Furthermore, FIG. 41C illustrates the case using the method which connects the other ends of the two linear electrodes EL constituting the pseudo loop coil PLC to each other, and supplies the current is to one end of one of these two linear electrodes EL and the current is to one end of the other linear electrode EL.

As can be understood from comparison between FIGS. 41D, 41E, and 41F, levels and distribution of pen signals are substantially the same for CDM1 and CDM3. Accordingly, detection of the position of the electromagnetic resonance pen P is similarly achievable by use of any of the methods illustrated in FIGS. 41A, 41B, and 41C to send alternating magnetic fields from the pseudo loop coils PLC. However, the method illustrated in FIG. 41C is inappropriate depending on impedance of the linear electrodes EL because a phase shift is caused at high impedance of the linear electrodes EL. The problem concerning this phase shift is not caused in the methods illustrated in FIGS. 41A and 41B.

Moreover, while described in the fourth embodiment has been the case where the degrees of CDM are 1, 3, and 7, the degree n of CDM may be one or any number larger than one.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A position detection method comprising:
connecting each of a plurality of sending coil conductors provided in parallel to a driving circuit in a first connection mode in a first period, and detecting, by using a plurality of detection coils, a first alternating magnetic field generated by an indicator according to first alternating magnetic fields simultaneously sent from the plurality of sending coil conductors in response to first alternating current supplied from the driving circuit, to obtain a first result;
connecting each of the plurality of sending coil conductors to the driving circuit in a second connection mode different from the first connection mode in a second period different from the first period, and detecting, by using the detection coils, a second alternating magnetic field generated by the indicator according to second alternating magnetic fields simultaneously sent from the plurality of sending coil conductors in response to second alternating current supplied from the driving circuit, to obtain a second result; and
deriving a position of the indicator based on the first result and the second result.

2. The position detection method according to claim 1, wherein each of the first connection mode and the second connection mode is configured to satisfy a relation where a plurality of vectors each indicating a connection state of a corresponding one of the sending coil conductors are linearly independent of each other.

3. The position detection method according to claim 1, wherein each of the first connection mode and the second connection mode is determined according to a matrix that has a rank equivalent to a number of the sending coil conductors that simultaneously send the first and the second alternating magnetic fields.

4. The position detection method according to claim 1, wherein the deriving of the position of the indicator derives the position of the indicator in an arrangement direction of the sending coil conductors based on the first result and the second result.

5. The position detection method according to claim 1, wherein each of the plurality of sending coil conductors includes two linear electrodes where current flows such that phases of time derivatives are opposite to each other.

6. The position detection method according to claim 5, wherein the current flowing in a first one of the two linear electrodes has a sign different from a sign of the current flowing in a second one of the two linear electrodes.

7. The position detection method according to claim 5, wherein the current flowing in a first one of the two linear electrodes has a sign identical to a sign of the current flowing in a second one of the two linear electrodes but has a level different from a level of the current flowing in the second one of the two linear electrodes.

8. The position detection method according to claim 5, wherein
a plurality of the linear electrodes constituting each of the plurality of sending coil conductors corresponds to some of a plurality of linear electrodes arranged in one line, and a corresponding one of the linear electrodes not constituting the plurality of sending coil conductors is not disposed between the plurality of linear electrodes constituting each of the plurality of sending coil conductors.

9. The position detection method according to claim 5, wherein
a plurality of the linear electrodes constituting each of the plurality of sending coil conductors corresponds to some of a plurality of linear electrodes arranged in one line, and a corresponding one of the linear electrodes not constituting the plurality of sending coil conductors is disposed between the plurality of linear electrodes constituting each of the plurality of sending coil conductors.

10. The position detection method according to claim 1, wherein each of the plurality of sending coil conductors includes a loop coil.

11. The position detection method according to claim 9, wherein the loop coils of each pair that constitute a pair of adjacent sending coil conductors overlap with each other.

12. The position detection method according to claim 1, further comprising:
connecting each of the plurality of sending coil conductors to the driving circuit in a third connection mode different from the first and second connection modes, and detecting, by using the detection coils, a third alternating magnetic field generated by the indicator according to third alternating magnetic fields simultaneously sent from the plurality of sending coil conductors in response to third alternating current supplied from the driving circuit, to obtain a third result,
wherein the deriving of the position of the indicator based on the first result, the second result, and the third result.

13. An integrated circuit configured to be connected to a plurality of sending coil conductors provided in parallel, a driving circuit, and a plurality of detection coils, the integrated circuit comprising:
at least one processor; and
at least one memory storing instructions that, when executed by the at least one processor, cause the integrated circuit to:
connect each of the plurality of sending coil conductors to the driving circuit in a first connection mode in a first period, and detect, by using the detection coils, a first alternating magnetic field generated by an indicator according to first alternating magnetic fields simultaneously sent from the plurality of sending coil conductors in response to first alternating current supplied from the driving circuit, to obtain a first result,
connect each of the plurality of sending coil conductors to the driving circuit in a second connection mode different from the first connection mode in a second period different from the first period, and detect, by using the detection coils, a second alternating magnetic field generated by the indicator according to second alternating magnetic fields simultaneously sent from the plurality of sending coil conductors in response to second alternating current supplied from the driving circuit, to obtain a second result, and
derive a position of the indicator based on the first result and the second result.

14. A sensor device that derives a position of an indicator, the sensor device comprising:
a plurality of sending coil conductors provided in parallel;
a driving circuit;
a plurality of detection coils; and
an integrated circuit connected to the plurality of sending coil conductors provided in parallel, the driving circuit, and the detection coils,
wherein the integrated circuit, in operation, connects each of the plurality of sending coil conductors to the driving circuit in a first connection mode in a first period, and detects, by using the detection coils, a first alternating magnetic field generated by the indicator according to first alternating magnetic fields simultaneously sent from the plurality of sending coil conductors in response to first alternating current supplied from the driving circuit, to obtain a first result,
wherein the integrated circuit, in operation, connects each of the plurality of sending coil conductors to the driving circuit in a second connection mode different from the first connection mode in a second period different from the first period, and detects, by using the detection coils, a second alternating magnetic field generated by the indicator according to second alternating magnetic fields simultaneously sent from the plurality of sending coil conductors in response to second alternating current supplied from the driving circuit, to obtain a second result, and
wherein the integrated circuit, in operation, derives a position of the indicator based on the first result and the second result.
